(19) United States
(12) Patent Application Publication
(10) Pub. No.: US 2009/0321662 A1
(43) Pub. Date: Dec. 31, 2009

(54) DETECTION METHOD, DETECTION APPARATUS, AND SAMPLE CELL AND KIT FOR DETECTION

(75) Inventor: Hisashi Ohtsuka, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/492,798

(22) Filed: Jun. 26, 2009

(30) Foreign Application Priority Data
Jun. 27, 2008 (JP) 2008-168251

(51) Int. Cl. G01N 21/64; G01N 21/05; G01N 21/76

(52) U.S. Cl. 250/459.1; 356/246; 436/172; 250/576

(57) ABSTRACT

A sensor chip includes a sensor-portion having at least a metal-layer deposited on a surface of a dielectric-plate. A fluorescent-label binding-substance in an amount corresponding to the amount of a detection target substance in a sample binds to the sensor-portion when the sample is placed in contact with the sensor-portion. The sensor-portion is irradiated with excitation-light to generate an enhanced electric-field on the sensor-portion. The amount of the detection target substance is detected based on the amount of light generated by excitation of a fluorescent-label in the fluorescent-label binding-substance in the enhanced electric-field. A magnetic-particle is added to the fluorescent-label binding-substance, and the amount of the detection target substance is detected while the fluorescent-label binding-substance modified with the magnetic-particle is attracted to the vicinity of the sensor-portion by a magnetic-field application means arranged on an opposite-surface side of the dielectric-plate, opposite to the metal-layer-deposited surface thereof.

### BACKGROUND OF THE INVENTION

1. Field of the Invention

The present invention relates to a detection method, a detection apparatus, a sample cell for detection and a kit for detection to detect a substance to be detected (a detection target substance) in a sample.

2. Description of the Related Art

Conventionally, in the field of bio-measurement and the like, a fluorescence detection method is widely used as a highly accurate and easy measurement method. In the fluorescence detection method, a sample that is presumed to contain a detection target substance that outputs fluorescence by being excited by irradiation with light having a specific wavelength is irradiated with excitation light having the specific wavelength. At this time, fluorescence is detected to confirm the presence of the detection target substance. Further, when the detection target substance is not a phosphor (fluorescent substance), a substance that has been labeled with a fluorescent dye and that specifically binds to the detection target substance is placed in contact with the sample. Then, fluorescence from the fluorescent dye is detected in a manner similar to the aforementioned method, thereby confirming the presence of the bond between the detection target substance and the substance that specifically binds to the detection target substance. In other words, presence of the detection target substance is confirmed, and this method is widely used.

In bio-measurement, an assay is performed, for example, by using a sandwich method, a competition method or the like. In the sandwich method, when an antigen, as a detection target substance, contained in a sample needs to be detected, a primary antibody that specifically binds to the detection target substance is immobilized on a substrate, and a sample is supplied onto the substrate to make the detection target substance specifically bind to the primary antibody. Further, a secondary antibody to which a fluorescent label has been attached, and that specifically binds to the detection target substance, is added to make the secondary antibody bind to the detection target substance. Accordingly, a so-called sandwich structure of (primary antibody)-(detection target substance)-(secondary antibody) is formed, and fluorescence from the fluorescent label attached to the secondary antibody is detected. In the competition method, a competitive secondary antibody that competes with the detection target substance, and that specifically binds to a primary antibody, and to which a fluorescent label has been attached, binds to the primary antibody in such a manner to compete with the detection target substance. Further, fluorescence from the competitive secondary antibody that has bound to the primary antibody is detected.

When the assay is performed as described above, an evanescent fluorescence method has been proposed. In the evanescent fluorescence method, fluorescence is excited by evanescent light to detect fluorescence only from the secondary antibody that has bound, through the detection target substance, to the primary antibody immobilized on the substrate, or fluorescence only from the competitive secondary antibody that has directly bound to the primary antibody. In the evanescent fluorescence method, fluorescence excited by evanescent waves that extend from the surface of the substrate is detected. The evanescent waves are generated by making excitation light that totally reflects on the surface of the substrate enter the substrate from the back side of the substrate.

Japanese Unexamined Patent Publication No. 2005-077338 (Patent Literature 1) proposes an evanescent fluorescence method. In the evanescent fluorescence method disclosed in Patent Literature 1, instead of immobilizing the primary antibody on the substrate, a bound product (bound substance) of (primary reaction body)-(detection target substance)-(secondary reaction body) is formed in liquid phase. Further, the bound product is localized in an area to which the evanescent waves extend, and fluorescence from the bound product is detected. Specifically, the primary reaction body that includes a primary antibody and a magnetic material and the secondary reaction body that includes a fluorescent substance and the secondary antibody are bound to the detection target substance to obtain the bound product. The magnetic material contained in the primary reaction body is attracted by a magnet, and the bound product is localized.

Meanwhile, in the evanescent fluorescent method, methods using electric-field enhancement effects by plasmon resonance are proposed to improve the sensitivity of detection in U.S. Pat. No. 6,194,223, M.M.L.M Vareiro et al., “Surface Plasmon Fluorescence Measurements of Human Chorionic Gonadotrophin: Role of Antibody Orientation in Obtaining Enhanced Sensitivity and Limit of Detection”, Analytical Chemistry, Vol. 77, pp. 2426-2431, 2005, and the like. In a surface plasmon enhancement fluorescence method, a metal layer is provided on the substrate, and excitation light is caused to enter the interface between the substrate and the metal layer from the back side of the substrate at an angle greater than or equal to a total reflection angle to generate surface plasmon resonance in the metal layer. Further, fluorescent signals are enhanced by the electric field enhancement action of the surface plasmons to improve the S/N (signal to noise) ratio.

Similarly, in the evanescent fluorescence method, a method using electric field enhancement effects by a waveguide mode is proposed in Spring 2007, the Japan Society of Applied Physics, Collection of Presentation Abstracts, No. 3, p. 1378. In this optical waveguide mode enhanced fluorescence spectroscopy (OWF), a metal layer and an optical waveguide layer including a dielectric and the like are sequentially formed on the substrate. Further, excitation light is caused to enter the substrate from the back side of the substrate at an angle that is greater than or equal to the total reflection angle to induce an optical waveguide mode in the optical waveguide layer by irradiation with the excitation light. Further, fluorescent signals are enhanced by the electric field enhancement effect by the optical waveguide mode.

Further, Specification of U.S. Patent Application Publication No. 20050053974 and T. Liebermann and W. Knoll, “Surface-plasmon field-enhanced fluorescence spectroscopy”, Colloids and Surfaces A, Vol. 171, pp. 115-130, 2000 propose a method for extracting radiation light (SPCE: Surface Plasmon-Coupled Emission) from the prism side. In the method, instead of detecting fluorescence output from a fluorescent label excited in the electric field enhanced by surface plasmons, the fluorescence newly induces surface plasmons in the metal layer, and radiation light generated by the surface plasmons is extracted from the prism side.

As described above, in bio-measurement or the like, various kinds of methods have been proposed as a method for detecting the detection target substance. In the methods, plasmon resonance or an optical waveguide mode is induced by irradiation with excitation light, and a fluorescent label is excited in an electric field enhanced by the plasmon resonance or the optical waveguide mode, and the fluorescence is directly or indirectly detected.

However, the electric field enhancement effects by the surface plasmon resonance and the optical waveguide mode sharply attenuate as a distance from the surface of the metal layer or the optical waveguide layer increases. Therefore, there is a problem that when the distance from the surface to the fluorescent label changes even slightly, signals from the fluorescent labels become different from each other, and varied.

For example, FIG. 18 is a schematic diagram illustrating an apparatus for detecting fluorescence by an electric field enhancement effect by surface plasmon resonance. In FIG. 18, a part in the vicinity of a sensor portion of the apparatus is illustrated. A gold film (thin-film, coating or layer) 102 is deposited on a surface of a prism (substrate) 101. Further, primary antibody B₁ is immobilized on the gold film 102. When a sandwich assay is performed, fluorescence from a fluorescent label (fluorescent dye molecule f in this case) attached to labeling secondary antibody B₂ is detected. The labeling secondary antibody B₂ binds to the primary antibody B₁ through antigen A. Excitation light is caused to enter the interface between the prism 101 and the gold film 102 at an angle greater than or equal to the total reflection angle to excite surface plasmons on the surface of the gold film 102. Accordingly, the electric field on the surface of the gold film 102 is enhanced. The fluorescent label (fluorescent dye molecule) f is excited in the enhanced electric field, and fluorescence is output. In FIG. 18, the graph shows distance-dependent characteristic of the strength (magnitude) of the electric field, the distance being measured from the surface of the sensor portion (surface of the gold film). As the graph shows, the strength of the electric field sharply decreases as the distance from the surface increases.

At this time, the maximum distance from the surface of the sensor portion to the fluorescent label f of the labeling secondary antibody is approximately 50 nm. When the distance from the surface of the sensor portion is approximately 50 nm, the intensity of fluorescence attenuates by 30% or more. Further, the primary antibody B₁ is not always immobilized upright on the surface of the sensor portion, and the primary antibody B₁ may fall along the surface by the flow of liquid, a three-dimensional obstacle or the like, and be immobilized in a lying or inclined state. Consequently, the distance from the surface of the fluorescent label f to the surface of the sensor portion is varied, and the intensity of the signal is varied.

When the method disclosed in Patent Literature 1 is used, it is possible to localize a bound product on the surface of the prism 101 without immobilizing the primary antibody B₁ on the surface of the prism 101. Specifically, in the method disclosed in Patent Literature 1, the primary reaction body including the primary antibody B₁ and the magnetic material M and the secondary reaction body including the fluorescent label (fluorescent dye molecule f in this case) and the secondary antibody B₂ are caused to bound to the detection target substance A, and the magnetic material M of the primary reaction body is attracted by a magnet to localize the bound product on the surface of the prism 101. As illustrated in FIG. 19, the primary antibody B₁ to which the magnetic material M has been attached is attracted onto the prism 101. However, some of bound products attracted onto the prism 101 are upright, but others are lying or inclined state or the like. Therefore, the distance from the surface of the prism 101 to the labeling secondary antibody that binds to the primary antibody through the detection target substance (in other words, a distance from the fluorescent label f to the surface of the prism) is varied. Hence, a similar problem that the intensity of the signal is varied exists.

### SUMMARY OF THE INVENTION

In view of the foregoing circumstances, it is an object of the present invention to provide a detection method and apparatus that can prevent variation in the intensities of signals, and that can efficiently utilize enhanced electric fields, and that can directly or indirectly detect fluorescence.

Further, it is another object of the present invention to provide a sample cell and a kit for detection that are used in the detection method of the present invention.

A detection method of the present invention is a detection method comprising the steps of:

preparing a sensor chip including a dielectric plate and a sensor portion that has at least a metal layer deposited on a surface of the dielectric plate;

binding a fluorescent-label binding substance in an amount corresponding to the amount of a detection target substance that is contained in a sample to the sensor portion by contacting the sample with the sensor portion;

irradiating the sensor portion with excitation light to generate an enhanced electric field on the sensor portion; and

detecting the amount of the detection target substance based on the amount of light generated by excitation of a fluorescent label contained in the fluorescent-label binding substance in the enhanced electric field, wherein a magnetic microparticle is added to the fluorescent-label binding substance to modify the fluorescent-label binding substance, and wherein the amount of the detection target substance is detected in a state in which the fluorescent-label binding substance modified with the magnetic microparticle is attracted to the vicinity of the sensor portion by a magnetic field application means that is arranged on an opposite-surface side of the dielectric plate, the opposite-surface being opposite to the surface of the dielectric plate on which the metal layer is deposited.

Here, the “fluorescent-label binding substance” is a binding substance to which a fluorescent label has been attached. The binding substance in an amount corresponding to the amount of the detection target binds to the surface of the sensor portion. For example, when an assay by using a sandwich method is performed, the fluorescent-label binding substance contains a fluorescent label and a binding substance that specifically binds to the detection target substance. When an assay by using a competition method is performed, the fluorescent-label binding substance contains a fluorescent label and a binding substance that competes with the detection target substance.

Further, the expression “detecting the amount of the detection target substance” means detecting presence of the detection target substance as well as detecting the amount of the detection target substance. Further, the amount of the detection target substance may mean not only the quantitative amount of the detection target substance but the qualitative value of the detection target substance.

Further, as the fluorescent label, a fluorescent dye molecule, such as FITC (fluorescein isothiocyanate) and Cy5, may be used directly. However, it is desirable to use a fluorescent substance containing a plurality of fluorescent dye molecules enclosed (included, encapsulated or the like) by a material that transmits fluorescence output from the plurality of fluorescent dye molecules.

Further, it is desirable that the size of the particle of the fluorescent substance is less than or equal to 5300 nm. It is more desirable that the size is in the range of 70 nm to 900 nm, and even more desirable that the size is in the range of 130 nm to 500 nm. In the specification of the present application, when the particle has substantially spherical form, the size of the particle of the fluorescent substance is the diameter of the particle. When the particle does not have spherical form, an average length of the maximum width and the minimum width of the particle is defined as the size of the particle.

Further, it is desirable that the material that encloses the fluorescent dye molecules prevents metal quenching that occurs when the fluorescent dye molecules are located close to the metal layer. Further, it is desirable that the fluorescent substance is an anti-quenching fluorescent substance. Here, the term “anti-quenching” means that the substance has a function of preventing metal quenching. Further, the material that prevents metal quenching should make the enclosed fluorescent dye molecules apart from the metal layer in such a manner that metal quenching does not occur.

Further, the magnetic microparticle may be added to the fluorescent-label binding substance by using any kind of method. However, when a first binding substance that specifically binds to the detection target substance is immobilized in the sensor portion of the sensor chip, and the fluorescent-label binding substance contains one of a second binding substance that specifically binds to the detection target substance and a third binding substance that competes with the detection target substance and that specifically binds to the first binding substance and the fluorescent label modified with the one of the second binding substance and the third binding substance, one of the second binding substance and the third binding substance may be modified with the magnetic microparticle.

Further, the fluorescent substance may be modified with the magnetic microparticle. Alternatively, the magnetic microparticle may be included in the material enclosing the plurality of fluorescent dye molecules in the fluorescent substance.

The electric field on the sensor portion may be enhanced by plasmon resonance. Alternatively, the electric field on the sensor portion may be enhanced by an optical waveguide mode.

Further, as a method for “detecting the amount of the detection target substance based on the amount of light generated by excitation of a fluorescent label contained in the fluorescent-label binding substance”, a method of directly detecting fluorescence from the fluorescent label may be adopted. Alternatively, the fluorescence may be detected indirectly.

Specifically, the amount of the detection target substance may be detected, for example, in any of the following manners (1) to (4):

(1) Plasmons are excited in a metal layer by irradiation with excitation light, and an enhanced electric field is generated by the plasmons. Further, the amount of the detection target substance is detected by detecting, as light generated by excitation of the fluorescent label, fluorescence output from the fluorescent label by excitation of the fluorescent label;

(2) Plasmons are excited in the metal layer by irradiation with the excitation light, and an enhanced electric field is generated by the plasmons. Further, the amount of the detection target substance is detected by detecting, as light generated by excitation of the fluorescent label, radiation light that radiates from the opposite surface of the dielectric plate. The radiation light is generated from plasmons that are newly induced in the metal layer by fluorescence output from the fluorescent label by excitation of the fluorescent label;

(3) The sensor chip includes an optical waveguide layer deposited on the metal layer. An optical waveguide mode is excited in the optical waveguide layer by irradiation with the excitation light, and an enhanced electric field is generated by the optical waveguide mode. Further, the amount of the detection target substance is detected by detecting, as the light generated by excitation of the fluorescent label, fluorescence generated by excitation of the fluorescent label; and

(4) The sensor chip includes an optical waveguide layer deposited on the metal layer. An optical waveguide mode is excited in the optical waveguide layer by irradiation with the excitation light, and an enhanced electric field is generated by the optical waveguide mode. Further, the amount of the detection target substance is detected by detecting, as the light generated by excitation of the fluorescent label, radiation light that radiates from the opposite-surface of the dielectric plate. The radiation light is generated from plasmons newly induced in the metal layer by fluorescence output from the fluorescent label by excitation of the fluorescent label.

In the methods (1) and (2), the metal layer may be a metal film (coating). Further, excitation light may be caused to enter the interface between the metal film and the substrate from the back side of the substrate at an angle greater than or equal to the total reflection angle to excite surface plasmons on the surface of the metal film. Alternatively, the metal layer may be formed by a metal fine structure body having an uneven pattern on the surface thereof, and the uneven pattern may include projections and depressions at cycles smaller than the wavelength of the excitation light. Alternatively, the metal layer may include a plurality of metal nanorods smaller than the wavelength of the excitation light. The metal layer may be formed in such a manner that localized plasmons are excited in the metal fine structure body or the metal nanorods by irradiation with excitation light.

Further, a detection apparatus according to the present invention is used in the detection method of the present invention. The detection apparatus is a detection apparatus comprising:

a housing unit that houses a sensor chip including a dielectric plate and a sensor portion that includes at least a metal layer deposited on a surface of the dielectric plate;

an excitation-light irradiation optical system that irradiates the sensor portion with excitation light;

a light detection means that detects light in an amount corresponding to the detection target substance, the light being generated by irradiation with the excitation light; and

a magnetic field generation means arranged on an opposite-surface side of the dielectric plate, the opposite-surface being opposite to the surface of the dielectric plate on which the metal layer is deposited when the sensor chip is housed in the housing unit.

Further, a sample cell for detection of the present invention is used in the detection method of the present invention. The sample cell for detection is a sample cell comprising:

a base (substrate) that has a flow path through which a liquid sample flows down;

an injection opening for injecting the liquid sample into the flow path, the injection opening being provided on the upstream side of the flow path;

an air hole for causing the liquid sample that has been injected from the injection opening to flow toward the downstream side of the flow path, the air hole being provided on the downstream side of the flow path; and

a sensor chip portion provided between the injection opening and the air hole in the flow path, wherein the sensor chip includes a dielectric plate that is provided on at least a part of the inner wall of the flow path and a sensor portion that has at least a metal layer deposited on a predetermined area of a sample-contact surface of the dielectric plate.

Further, in the sample cell for detection, it is desirable that a first binding substance that specifically binds to a detection target substance is immobilized on the sensor portion. In this case, the fluorescent-label binding substance may contain one of a second binding substance that specifically binds to the detection target substance and a third binding substance that competes with the detection target substance and that specifically binds to the first binding substance and a fluorescent label that is modified with the one of the second binding substance and the third binding substance. Further, a magnetic microparticle may be added to the fluorescent-label binding substance. Further, the fluorescent-label binding substance may be immobilized in the flow path on the upstream side of the sensor portion.

Further, in the sample cell of the present invention, when the fluorescent-label binding substance contains the second binding substance and the fluorescent label that has been modified with the second binding substance, it is desirable to use a sandwich method to perform an assay. When the fluorescent-label binding substance contains the third binding substance and the fluorescent label that has been modified with the third binding substance, it is desirable to use a competition method to perform an assay.

Further, in the sensor portion, an optical waveguide layer may be provided on the metal layer.

A kit for detection of the present invention is used in the detection method of the present invention. The kit for detection is a kit comprising:

a sample cell; and

a solution for labeling,

wherein the sample cell includes:

a base that has a flow path through which a liquid sample flows down;

an injection opening for injecting the liquid sample into the flow path, the injection opening being provided on the upstream side of the flow path;

an air hole for causing the liquid sample that has been injected from the injection opening to flow toward the downstream side of the flow path, the air hole being provided on the downstream side of the flow path;

a sensor chip portion provided between the injection opening and the air hole in the flow path, the sensor chip including a dielectric plate that is provided on at least a part of the inner wall of the flow path and a sensor portion that has at least a metal layer deposited on a predetermined area of a sample-contact surface of the dielectric plate; and

a first binding substance that is immobilized on the sensor portion, and that specifically binds to a detection target substance, and wherein the solution for labeling contains a fluorescent-label binding substance that contains one of a second binding substance that specifically binds to the detection target substance and a third binding substance that competes with the detection target substance and that specifically binds to the first binding substance and a fluorescent label that is modified with the one of the second binding substance and the third binding substance, and wherein a magnetic microparticle is added to the fluorescent-label binding substance, and wherein the solution for labeling is injected into the flow path to flow down the flow path together with the injection of the liquid sample or after the liquid sample has flowed down the flow path.

Further, in the kit for detection, an optical waveguide layer may be provided on the metal layer in the sensor portion.

In the kit for detecting fluorescence of the present invention, when the solution for labeling contains, as the fluorescent-label binding substance, the second binding substance and the fluorescent label that is modified with the second binding substance, an assay by using a sandwich method is appropriate. In contrast, when the solution for labeling contains, as the fluorescent-label binding substance, the third binding substance and the fluorescent label that is modified with the third binding substance, an assay by using a competition method is more appropriate.

Further, it is desirable that the material of the metal layer contains, as a main component, at least one kind of metal selected from the group consisting of Au, Ag, Cu, Al, Pt, Ni, Ti, and alloys thereof. Here, the term “main component” is defined as a component contained at greater than or equal to 90% by mass.

According to the detection method and apparatus of the present invention, the magnetic microparticle is added to the fluorescent-label binding substance that binds to the sensor portion based on the amount of the detection target substance contained in the sample. Further, the fluorescent label contained in the fluorescent-label binding substance is excited and the amount of light generated by the excitation is detected in a state in which the fluorescent-label binding substance is attracted to the surface of the sensor portion by the magnetic field application means. Since the light is detected while the fluorescent-label binding substance is attracted to the surface of the sensor portion, it is possible to efficiently use the electric field on the surface of the sensor portion at which the degree of enhancement of the electric field is high. Further, since it is possible to make the distance from the surface of the fluorescent label uniform (even), variation in the intensity of signals can be prevented. In other words, it is possible to detect stable signals at an excellent S/N ratio, and to accurately detect presence and/or the amount of the detection target substance.

When the sample cell for detection of the present invention or the kit for detection of the present invention is used, it is possible to easily perform the detection method of the present invention. Further, it is possible to effectively use the enhanced electric field, and to prevent variation in the intensity of signals. Further, it is possible to accurately detect presence and/or the amount of the detection target substance.

### BRIEF DESCRIPTION OF THE DRAWINGS

FIG. 1 is a schematic diagram illustrating the structure of a fluorescence detection apparatus according to a first embodiment of the present invention;

FIG. 2A is a diagram illustrating a manner in which a magnetic microparticle is added to a fluorescent-label binding substance (No. 1);

FIG. 2B is a diagram illustrating a manner in which a magnetic microparticle is added to a fluorescent-label binding substance (No. 2);

FIG. 2C is a diagram illustrating a manner in which a magnetic microparticle is added to a fluorescent-label binding substance (No. 3);

FIG. 2D is a diagram illustrating a manner in which a magnetic microparticle is added to a fluorescent-label binding substance (No. 4);

FIG. 3 is a diagram illustrating a design modification example of an excitation light irradiation optical system;

FIG. 4 is a schematic diagram illustrating the structure of a fluorescence detection apparatus according to a second embodiment of the present invention;

FIG. 5A is a schematic diagram illustrating a sensor portion of a sensor chip used in the fluorescence detection apparatus according to the second embodiment of the present invention;

FIG. 5B is a schematic diagram illustrating a sensor portion of a sensor chip used in the fluorescence detection apparatus according to the second embodiment of the present invention;

FIG. 5C is a schematic diagram illustrating a sensor portion of a sensor chip used in the fluorescence detection apparatus according to the second embodiment of the present invention;

FIG. 6 is a schematic diagram illustrating the structure of a detection apparatus according to a third embodiment of the present invention;

FIG. 7 is a schematic diagram illustrating the structure of a detection apparatus according to a fourth embodiment of the present invention;

FIG. 8 is a schematic diagram illustrating the structure of a detection apparatus according to a fifth embodiment of the present invention;

FIG. 9 is a schematic diagram illustrating a fluorescent substance having a metal coating;

FIG. 10A is a plan view of a sample cell according to the first embodiment of the present invention;

FIG. 10B is a sectional side view of the sample cell according to the first embodiment of the present invention;

FIG. 11 is a sectional side view of a sample cell according to the second embodiment of the present invention;

FIG. 12 is a diagram illustrating the procedure of an assay by a sandwich method using the sample cell according to the second embodiment of the present invention;

FIG. 13 is a sectional side view illustrating the sample cell according to the third embodiment of the present invention;

FIG. 14 is a diagram illustrating the procedure of an assay by a competition method using the sample cell according to the third embodiment of the present invention;

FIG. 15 is a sectional side view illustrating a design modification example of a sample cell;

FIG. 16 is a schematic diagram illustrating the structure of a kit for detecting fluorescence according to an embodiment of the present invention;

FIG. 17 is a diagram illustrating the procedure of an assay by a sandwich method using the kit for detecting fluorescence;

FIG. 18 is a diagram illustrating conventional example 1; and

FIG. 19 is a diagram illustrating conventional example 2.

### DESCRIPTION OF THE PREFERRED EMBODIMENTS

Hereinafter, embodiments of the present invention will be described with reference to the drawings. In each of the diagrams, the size of each unit or element differs from the actual size thereof for the purpose of explanation.

### “Detection Method and Apparatus”

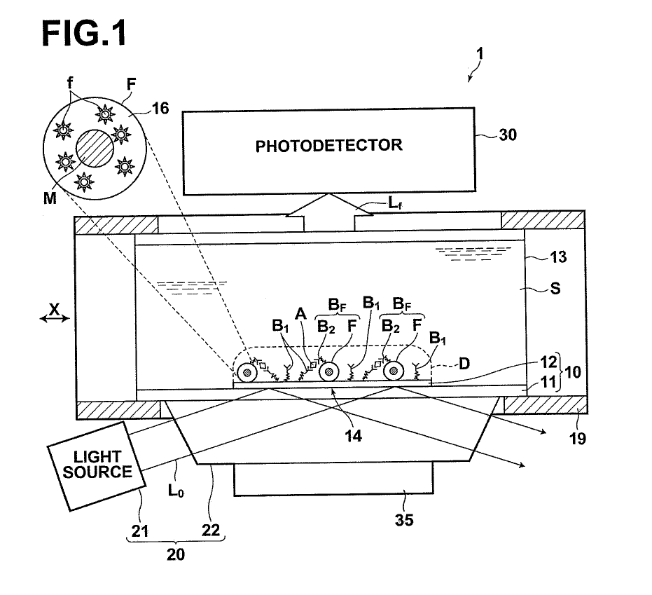

In a detection method according to the present invention, for example, a sensor chip 10 including a dielectric plate 11 and a sensor portion 14, as illustrated in FIG. 1, is used. The sensor portion 14 includes at least a metal layer 12 that is deposited on a surface of the dielectric plate 11. Further, a sample is placed in contact with the sensor portion 14 to make fluorescent-label binding substance B_{F} corresponding to the amount of detection target substance A (substance to be detected) contained in the sample bind onto the sensor portion 14. Further, the sensor portion 14 is irradiated with excitation light L₀ to enhance the electric field on the sensor portion 14, and the amount of the detection target substance A is detected based on the amount of light generated by excitation of the fluorescent label contained in the fluorescent-label binding substance B_{F} in the enhanced electric field D. In the detection method of the present invention, magnetic microparticle M is added to the fluorescent-label binding substance B_{F}, and the amount of the detection target substance A is detected in a state in which the fluorescent-label binding substance B_{F}, to which the magnetic microparticle M has been added, is attracted to the vicinity of the sensor portion 14 on the dielectric plate 11 by a magnetic field application means 35. The magnetic field application means 35 is arranged on an opposite-surface side of the dielectric plate 11, the opposite-surface being opposite to the surface of the dielectric plate on which the metal layer 12 is deposited.

Further, a detection apparatus of the present invention performs the detection method of the present invention. The detection apparatus includes a housing unit 19 for housing the sensor chip 10, an excitation light irradiation optical system 20, a light detection means 30, and a magnetic field generation means 35. The excitation light irradiation optical system 20 irradiates the sensor portion 14 with excitation light L₀, and the light detection means 30 detects light in an amount corresponding to detection target substance A, the light being generated by irradiation with the excitation light L₀. The magnetic field generation means 35 is arranged on an opposite-surface side of the dielectric plate 11, the opposite-surface being opposite to the surface of the dielectric plate 11 on which the metal layer is deposited when the sensor chip 10 is housed in the housing unit 19.

As the fluorescent label, a molecule of fluorescent dye may be used alone. However, it is desirable that a fluorescent substance containing a plurality of fluorescent dye molecules f enclosed (included, encapsulated or the like) by a material 16 that transmits fluorescence output from the plurality of fluorescent dye molecules f is used as the fluorescent label. An enlarged view of the plurality of fluorescent dye molecules f enclosed by the material 16 is illustrated in FIG. 1. The fluorescent substance F containing the plurality of fluorescent dye molecules f enclosed by the material 16 is desirable, because it is possible to increase the amount of fluorescence. Further, it is desirable to use, as the material 16 that transmits fluorescence L_{f}, a material that prevents metal quenching that occurs when the fluorescent dye molecule f is located close to the metal layer 12. Further, it is desirable that the fluorescent substance F is an anti-quenching fluorescent substance that can prevent quenching.

When the fluorescent dye molecule f is located too close to the metal layer 12, there is a problem that quenching occurs due to transfer of energy to the metal. Therefore, when a single molecule of the fluorescent dye f is used alone as the label, metal quenching may be prevented by forming a self-assembled monolayer (SAM) on the metal layer 12, and by further applying carboxymethyl dextran (CMD) coating to the SAM to make the metal layer and the fluorescent dye molecule apart from each other. In the anti-quenching fluorescent substance, the fluorescent dye molecules f are covered (coated or enclosed) by a material that prevents quenching. Therefore, it is possible to make the metal layer 12 and the fluorescent dye molecules f apart from each other so that a sufficient distance is maintained therebetween without proving a separate coating or layer for preventing metal quenching on the metal layer 12. Therefore, it is possible to effectively prevent metal quenching by using a very simple method.

It is desirable that the diameter of the particle of the anti-metal-quenching fluorescent substance is less than or equal to 5300 nm. Further, it is more desirable that the diameter is in the range of 70 nm to 900 nm, and even more desirable that the diameter is in the range of 130 nm to 500 nm. Examples of the anti-quenching material are polystyrene, SiO₂, and the like. However, the material is not limited to these materials as long as the material can enclose the fluorescent dye molecules f, and transmit fluorescence from the fluorescent dye molecules f to output the fluorescence to the outside of the anti-quenching fluorescent substance, and prevent metal quenching of the fluorescent dye molecules f.

The anti-quenching fluorescent substance may be produced, for example, as follows:

First, polystyrene particles (Estapor, (φ500 nm, 10% solid, carboxyl group, product No. K1-050) are prepared to obtain 0.1% solid in phosphate (polystyrene solution: pH7.0).

Next, an acetic acid ethyl solution (1 mL) containing 0.3 mg of fluorescent dye molecules (Hayashibara Biochemical Labs., Inc., NK-2014 (excitation ˜780 nm)) is produced.

Further, the polystyrene solution and the fluorescent dye solution are mixed together, and impregnated while the mixture evaporates. After then, centrifugation (15000 rpm, 4° C., 20 minutes, twice) is performed, and the supernatant is removed. Accordingly, anti-quenching fluorescent substance F, in which fluorescent dyes are enclosed by polystyrene that has a function of preventing metal quenching, is obtained. When the anti-quenching fluorescent substance F is produced by impregnating the fluorescent dye into the polystyrene particle through the aforementioned processes, the diameter of the particle of the anti-quenching fluorescent substance F is the same as the diameter of the particle of polystyrene (φ500 nm in the above example).

As described already, when the fluorescent dye molecules are located too close to the metal layer, quenching occurs due to energy transfer to the metal. When the metal is a flat plane having a semi-infinite thickness, the magnitude (degree) of energy transfer is in inverse proportion to the cube of the distance. When the metal is a flat plane having a finitely thin thickness, the magnitude of energy transfer is in inverse proportion to the fourth power of the distance. Further, when the metal is microparticles, the magnitude of energy transfer is in inverse proportion to the sixth power of the distance. Therefore, it is desirable that the distance between the metal layer 12 and the fluorescent dye molecules f is at least a few nm, and it is more desirable that the distance is greater than or equal to 10 nm.

Meanwhile, the fluorescent dye molecules are excited by evanescent waves that extend to the surface of the metal film (layer), and which are enhanced by surface plasmons. It is known that the range (distance from the surface of the metal film) in which the evanescent waves reach is approximately the wavelength λ of the excitation light, and that the strength of the electric field sharply attenuates exponentially based on the distance from the surface of the metal film. Since it is desirable that the strength of the electric field for exciting the fluorescent dye molecules is as great as possible, it is desirable that the distance between the surface of the metal film and the fluorescent dye molecules is less than 100 nm to effectively excite the fluorescent dye molecules.

When the anti-quenching fluorescent substance is used as the fluorescent label, the fluorescent dye molecules are covered by the anti-quenching material. Therefore, the fluorescent dye molecules do not directly contact the metal layer. Further, since a plurality of fluorescent dye molecules are included in the anti-quenching fluorescent substance, it is possible to easily realize a state in which the plurality of fluorescent dye molecules are present within a distance of 10 to 100 nm from the metal layer.

The fluorescent-label binding substance B_{F} is a binding substance to which a fluorescent label has been attached, and the fluorescent-label binding substance B_{F} in an amount corresponding to the amount of the detection target substance A binds onto the sensor portion 14. As illustrated in FIG. 1, when an assay is performed by using a sandwich method, the fluorescent-label binding substance B_{F} includes a binding substance that specifically binds to the detection target substance and a fluorescent label. When an assay is performed by using a competition method, which will be described later, the fluorescent-label binding substance B_{F} includes a binding substance that competes with the detection target substance and a fluorescent label. Specifically, when the sensor chip 10 in which first binding substance B₁ that specifically binds to the detection target substance A is immobilized in the sensor portion 14 is used, the fluorescent-label binding substance B_{F} including second binding substance B₂ that specifically binds to the detection target substance A and fluorescent label F (or f) that is modified with the binding substance B₂ is used in the sandwich method. In the competition method, the fluorescent-label binding substance B_{F} including a third binding substance that competes with the detection target substance A and that specifically binds to the first binding substance B₁ and fluorescent label F (or f) that is modified with the third binding substance is used. When the detection target substance A is an antigen, a so-called primary antibody should be used as the first binding substance B₁, and a so-called labeling secondary antibody should be used as the fluorescent-label binding substance.

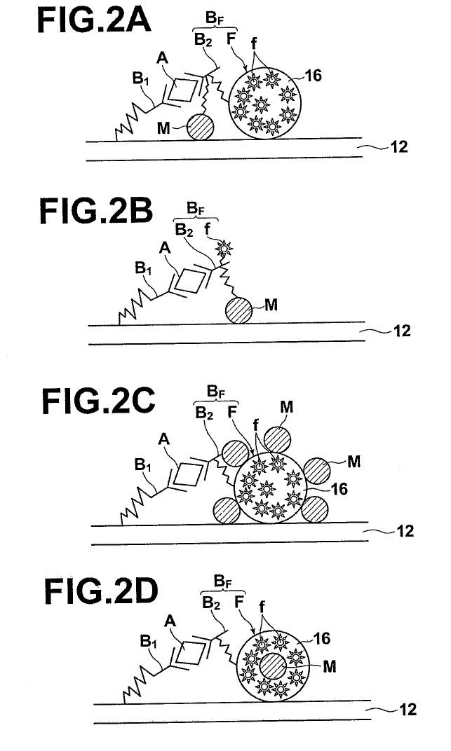

A method for adding a magnetic microparticle to the fluorescent-label binding substance will be described with reference to FIGS. 2A through 2D. FIGS. 2A through 2D illustrate an example of an assay by using a sandwich method.

As illustrated in FIGS. 2A and 2B, the second binding substance B₂ that has modified the fluorescent substance F, which is a fluorescent label (or the second binding substance B₂ that modifies the fluorescent dye molecule f, which is a fluorescent label) is modified with magnetic microparticle M. Both of the fluorescent label and the magnetic microparticle M bind to the same binding substance B₂. Therefore, when the magnetic microparticle M is attracted to the sensor portion (or to the vicinity of the sensor portion), it is possible to attract the fluorescent label together with the magnetic microparticle M.

As illustrated in FIG. 2C, the magnetic microparticle M may modify the surface of the fluorescent substance F, which is a fluorescent label. Further, an amino coupling method may be used to modify the fluorescent substance F with the magnetic microparticle M. Alternatively, as illustrated in FIG. 2D, the magnetic microparticle M may be included in the material 16 in the fluorescent substance F. The fluorescent substance F that includes the magnetic microparticle M and the fluorescent dye molecules f can be prepared by using a polymer particle that includes the magnetic microparticle M (for example, M1-030/40, ferrite-containing polyethylene bead, manufactured by MORITEX Corporation, φ˜400 nm). Further, a fluorescent dye is impregnated in the polymer portion of the particle to prepare the fluorescent substance F that includes the magnetic microparticle M and the fluorescent dye molecules f.

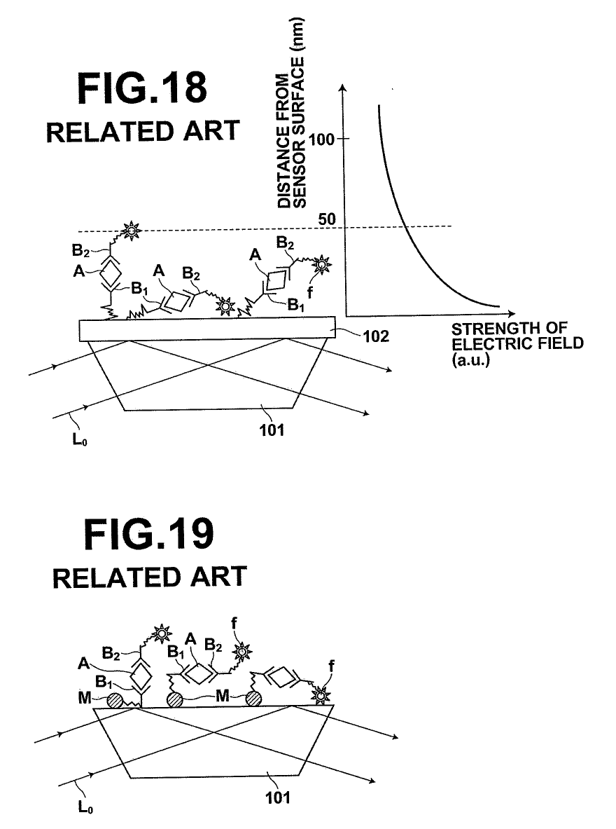

In all of the aforementioned cases, when the magnetic microparticle M is attracted onto the metal layer 12 by the magnetic field application means, the fluorescent label is also attracted onto the metal layer 12, as illustrated in FIGS. 2A through 2D. In the examples illustrated in FIGS. 18 and 19, which have been described already, the fluorescent label is not sufficiently attracted onto the metal layer. Further, in the examples illustrated in FIGS. 18 and 19, the distance from the fluorescent label to the surface of the sensor surface is varied, because the bound products are either upright or lying. However, when the magnetic microparticle M is added to the fluorescent-label binding substance B_{F}, it is possible to efficiently and evenly attract the fluorescent label to the surface of the sensor portion. Therefore, it is possible to prevent variation in signals. Further, it is possible to stably detect signals at an excellent S/N ratio.

It is desirable that the diameter of the magnetic microparticle M is less than or equal to 100 nm. It is more desirable that the diameter is approximately in the range of 15 to 40 nm. Further, the magnetic microparticle M should be made of a magnetic material selected from the group consisting of ferrosoferric oxide (iron oxide black), iron sesquioxide, various kinds of ferrites, metals, such as iron, manganese, nickel, cobalt, chromium, and platinum (Pt), and alloys of these metals. When the magnetic microparticle made of Pt is used, localized plasmons are generated, and it is possible to increase the intensity of signals by the electric field enhancement effect of the localized plasmons.

The magnetic field application means 35 that attracts the magnetic microparticle M to the sensor portion 14 may be an electromagnet. Alternatively, the magnetic field application means 35 may be a permanent magnet. When the electromagnet is used as the magnetic field application means 35, it is possible to generate a magnetic field by sending electric current to the coil of the electromagnet when the magnetic microparticle should be attracted. When the permanent magnet is used, the permanent magnet should be placed under the sensor portion, as illustrated in FIG. 1, to attract the magnetic microparticle. When the permanent magnet should not apply a magnetic field, the permanent magnet should be moved away from the sensor portion so that a magnetic field is not generated in the vicinity of the sensor portion. Examples of the permanent magnet are alnico magnet, ferrite magnet, MK steel, KS steel, samarium cobalt magnet, neodymium magnet, and the like. However, the permanent magnet is not limited to these magnets.

In the present invention, the electric field on the sensor portion is enhanced, and light output by excitation of the fluorescent label in the enhanced electric field is detected. The electric field may be enhanced by surface plasmon resonance, or by localized plasmon resonance. Alternatively, the electric field may be enhanced by an optical waveguide mode. Further, fluorescence output from the fluorescent label may be detected either directly or indirectly. Specific examples will be described in each of the following embodiments.

### First Embodiment

A detection method and apparatus according to a first embodiment will be described with reference to FIG. 1. FIG. 1 is a schematic diagram illustrating the structure of the whole detection apparatus of the first embodiment. The detection method and apparatus in this embodiment enhances an electric field by surface plasmon resonance, and detects fluorescence excited in the enhanced electric field.

In the fluorescence detection method of the present embodiment, a sensor chip 10 including a dielectric plate 11 and a sensor portion 14 that has a metal layer 12 deposited in a predetermined area on a surface of the dielectric plate 11 is used.

In the sensor chip 10, a metal film (thin-film, coating or the like), as the metal layer 12, is deposited on a predetermined area on a surface of the dielectric plate 11, such as a glass plate. The metal film (layer) 12 may be formed on a surface of the dielectric plate 11 by forming (placing) a mask that has an opening in the predetermined area, and by depositing metal by using a well-known vapor-deposition method (evaporation method). It is desirable that the thickness of the metal layer 12 is appropriately determined, based on the material of the metal layer 12 and the wavelength of the excitation light, so that surface plasmons are strongly excited. For example, when a laser beam that has a center wavelength of 780 nm is used as the excitation light, and a gold (Au) film is used as the metal layer 12, it is desirable that the thickness of the metal layer is 50 nm±20 nm. Further, it is more desirable that the thickness is 47 nm±10 nm. Further, it is desirable that the metal layer contains, as a main component, at least one kind of metal selected from the group consisting of Au, Ag, Cu, Al, Pt, Ni, Ti, and alloys thereof.

Further, in the present embodiment, a sample retaining unit 13 for retaining liquid sample S on the sensor chip 10 is provided. The sensor chip 10 and the sample retaining unit 13 constitute a box-form cell that can retain the liquid sample. However, when a minute amount of liquid that can remain on the surface of the sensor chip 10 by surface tension is measured, it is not necessary that the sample retaining unit 13 is provided.

The detection apparatus 1 of the present invention includes a housing unit 19 that houses the sensor chip 10. The detection apparatus 1 also includes an excitation light irradiation optical system 20, and a photodetector 30. The excitation light irradiation optical system 20 causes excitation light L₀ to enter the interface between the dielectric plate 11 and the metal layer 12 of the sensor chip 10 housed in the housing unit 19 from the opposite surface of the sensor chip 10, the opposite surface being opposite to the metal-layer-formation surface of the sensor chip 10, at an angle greater than or equal to a total reflection angle. The photodetector 30 detects fluorescence L_{f} output by irradiation with the excitation light L₀. Further, a magnetic field generation means 35 is arranged on an opposite-surface side of the dielectric plate 11, the opposite-surface being opposite to the surface of the dielectric plate 11 on which the metal layer is deposited when the sensor chip 10 is housed in the housing unit 19.

The excitation-light irradiation optical system 20 includes a light source 21, such as a semiconductor laser (LD), which outputs the excitation light L₀. Further, the excitation-light irradiation optical system 20 includes a prism 22 arranged in such a manner that a surface of the prism 22 contacts with the dielectric plate 11. The prism 22 guides the excitation light L₀ into the dielectric plate 11 so that the excitation light L₀ totally reflects at the interface between the dielectric plate 11 and the metal layer 12. Further, the prism 22 and the dielectric plate 11 are in contact with each other through refractive-index-matching oil. The light source 21 is arranged in such a manner that the excitation light L₀ enters the prism from another surface of the prism 22 and enters a sample-contact-surface 10a of the sensor chip 10 at an angle greater than or equal to a total reflection angle. Further, the light source 21 is arranged in such a manner that the excitation light L₀ enters the metal layer at a specific angle that generates surface plasmon resonance. Further, a light guide member may be arranged between the light source 21 and the prism 22, if necessary. Further, the excitation light L₀ is caused to enter the interface between the dielectric plate 11 and the metal layer 12 at p—polarized light so as to generate surface plasmons.

As the photodetector 30, a CCD, a PD (photodiode), a photomultiplier, c-MOS or the like may appropriately be used.

The housing unit 19 is structured in such a manner that when the sensor chip 10 is housed in the housing unit 19, the sensor portion 14 of the sensor chip 10 is arranged on the prism 22 and fluorescence is detected by the photodetector 30. The sensor chip 10 can be inserted into the housing unit 19 or removed therefrom in the direction of arrow X in FIG. 1.

A fluorescence detection method according to the present invention using the fluorescence detection apparatus 1 will be described. Here, a case in which antigen A contained in sample S is detected as measurement target substance will be described.

As the sensor chip 10, a sensor chip in which a metal film (metal layer) 12 of the sensor chip is modified with primary antibody B₁, as the first binding substance that specifically binds to the antigen A, is prepared.

First, sample S, which is an examination object (examination target), is poured into the sample retaining unit 13, to make the sample S in contact with the metal film 12 of the sensor chip 10. Next, a solution containing fluorescent-label binding substance B_{F} is poured into the sample retaining unit 13 in a similar manner. The fluorescent-label binding substance B_{F} includes secondary antibody B₂, which is a second binding substance that specifically binds to the antigen A, and fluorescent label F. In this case, the primary antibody B₁ that is used for surface modification of the metal film 12 and the secondary antibody B₂ of the fluorescent-label binding substance B_{F} are selected so that they bind to different sites of the antigen A, which is the detection target substance. Here, fluorescent substance F that includes magnetic microparticle M and fluorescent dye molecules f is used. When the antigen A is present in the sample S, the antigen A specifically binds to the primary antibody B₁, and the secondary antibody B₂ in the fluorescent-label binding substance B_{F} binds to the antigen A. Consequently, a sandwich (sandwich structure) is formed. After then, a buffer solution is poured into the sample retaining unit 13 to separate the bound product and unreacted fluorescent-label binding substance B_{F} from each other, and the unreacted fluorescent-label binding substance B_{F} is removed.

These processes may be performed before the sensor chip 10 is set in the housing unit 19. Alternatively, the processes may be performed after the sensor chip 10 is set in the housing unit 19. Further, the timing of labeling the detection target substance (antigen A) is not particularly limited. A fluorescent label may be added to the sample in advance before the detection target substance (antigen A) binds to the first binding substance (primary antibody B₁).

After then, with the sensor chip 10 set in the housing unit 19, a magnetic field is generated by the magnetic field application means 35 to attract the magnetic microparticle M to the sensor portion 14. In the present embodiment, the magnetic microparticle M is included in the fluorescent substance F. Therefore, attracting the magnetic microparticle M is equivalent to attracting the fluorescent substance F. In a state in which the fluorescent substance F is attracted to the sensor portion 14 as described above, excitation light L₀ is output to a predetermined area of the dielectric plate 11 of the sensor chip 10 from the excitation light irradiation optical system 20. The excitation light irradiation optical system 20 outputs the excitation light L₀ in such a manner that the excitation light L₀ enters the interface between the dielectric plate 11 and the metal film 12 at a specific incident angle that is greater than or equal to a total reflection angle. When the light L₀ enters the interface in such a manner, evanescent waves extend to the sample S on the metal film 12, and surface plasmons are excited in the metal film 12 by the evanescent waves. Further, the optical electric field (an electric field induced by evanescent waves) that has been generated on the metal layer by the incident excitation light is enhanced by the surface plasmons. Accordingly, electric field enhanced region D is formed on the metal layer. Since the fluorescent substance F including the magnetic microparticle M has been attracted to the electric field enhanced region D by the magnetic field application means 35, when the fluorescent dye molecules f in the fluorescent substance F are excited, fluorescence L_{f} is output. The fluorescence is enhanced by the electric field enhancement effect by the surface plasmons. The fluorescence L_{f} is detected by the photodetector 30. It is possible to detect the presence and/or amount of the detection target substance that has bound to the fluorescent-label binding substance by detecting fluorescence at the photodetector 30.

As described above, the magnetic microparticle M has been added to the fluorescent-label binding substance. Therefore, it is possible to detect fluorescence in a state in which the magnetic microparticle M has been attracted to the sensor portion by the magnetic field application means, such as a magnet. Hence, it is possible to obtain stable signals at an excellent S/N ratio. Further, it is possible to improve the reliability of examination. Specifically, the variation in signals is reduced by approximately 10%, compared with a case in which the magnetic microparticle M is not added.

When the reaction occurs (when a sandwich is formed), if a magnetic field is applied, the fluorescent-label binding substance is attracted onto the sensor portion. Therefore, it is possible to improve the reaction speed by the condensing effect and to reduce a time period for reaction. After the reaction, when unreacted fluorescent-label binding substance is washed away before detection, the application of the magnetic field should be temporarily stopped to wash away the unreacted fluorescent-label binding substance. After the unreacted fluorescent-label binding substance is washed away, a magnetic field should be applied again.

### <Design Modification Example of First Embodiment>

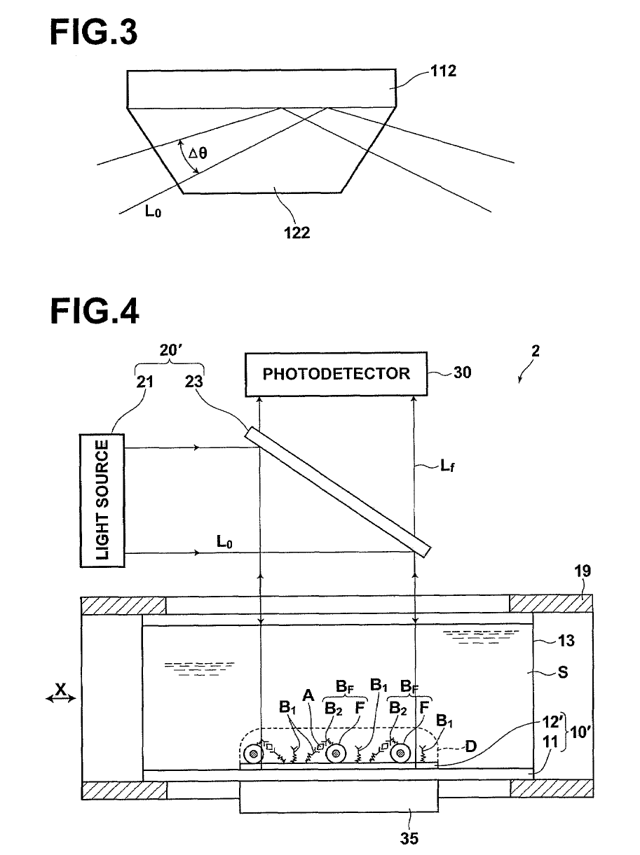

In each of the aforementioned examples, the excitation light L₀ is collimated light that enters the interface at predetermined angle θ. Alternatively, the excitation light may be a fan beam (condensed light), as schematically illustrated in FIG. 3, which has angle width Δθ with respect to angle θ. When the excitation light is a fan beam, the excitation light enters the interface between the prism 122 and the metal film 112 on the prism 122 at an incident angle within the range of θ-Δθ/2 to θ+Δθ/2. When a resonance angle is present in the range of angles, it is possible to excite surface plasmons in the metal film 112. Further, the refractive index of the medium changes when the sample is supplied onto the metal film. In other words, the refractive index of the medium before supply of the sample and the refractive index of the medium after supply of the sample differ from each other. Therefore, the resonance angle at which surface plasmons are generated changes. When the collimated light is used as the excitation light as in the aforementioned examples, it is necessary to adjust the incident angle of the collimated light every time when the resonance angle changes. However, when the fan beam, as illustrated in FIG. 3, is used, since the incident angle of the fan beam has a certain width, it is possible to cope with the change in the resonance angle without adjusting the incident angle. Further, it is desirable that the fan beam has flat distribution, in which a change in the intensity of light according to the incident angle is small.

### Second Embodiment

A detection method and apparatus according to a second embodiment will be described with reference to FIG. 4. FIG. 4 is a schematic diagram illustrating the structure of the whole detection apparatus of the second embodiment. The detection method and apparatus in this embodiment enhances an electric field by localized plasmon resonance, and detects fluorescence excited in the enhanced electric field. In the following descriptions, the same reference numerals will be assigned to elements corresponding to the elements in the first embodiment.

In a fluorescence detection apparatus 2 illustrated in FIG. 4, a sensor chip 10′ and an excitation light irradiation optical system 20′ differ from the elements of the fluorescence detection apparatus 1 of the first embodiment.

The sensor chip 10′ includes, as a metal layer 12′ provided on the dielectric plate 11, a metal fine structure body or a plurality of metal nanorods, which generate so-called localized plasmons by irradiation with the excitation light. The metal fine structure body includes an uneven structure (an uneven pattern, or projections/depressions) that is smaller than the wavelength of the excitation light L₀. Further, the size of each of the plurality of metal nanorods is smaller than the wavelength of the excitation light L₀. When the metal layer 12′ as described above, which generates localized plasmons, is provided, it is not necessary that the excitation light enters the interface between the metal layer 12′ and dielectric plate 11 at a total reflection angle. Therefore, an excitation light irradiation optical system 20′ is structured in such a manner that the excitation light L₀ is output to the sensor chip 10′ from the upper side of the dielectric plate 11.

The excitation light irradiation optical system 20′ includes a light source 21, such as a semiconductor laser (LD), and a half mirror 23. The light source 21 outputs the excitation light L₀, and the half mirror 23 reflects the excitation light L₀, and guides the excitation light L₀ to the sensor chip 10′. The half mirror 23 reflects the excitation light L₀, and transmits fluorescence L_{f}.

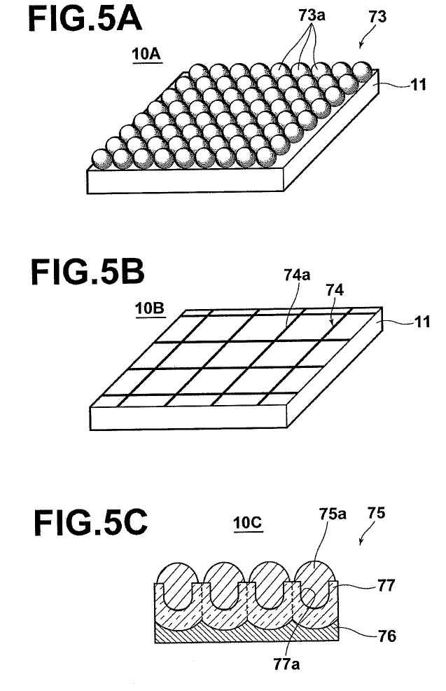

A specific example of the sensor chip 10′ will be described with reference to perspective views illustrated in FIGS. 5A through 5C.

A sensor chip 10A illustrated in FIG. 5A includes the dielectric plate 11 and a metal fine structure body 73. The metal fine structure body 73 includes a plurality of metal particles 73a fixed in array form on a predetermined area of the dielectric plate 11. The arrangement pattern of the metal particles 73a may be appropriately designed, and it is desirable that the arrangement pattern is substantially regular. This structure is designed in such a manner that an average particle diameter of the metal particles 73a and an average pitch thereof are smaller than the wavelength of the excitation light L₀.

A sensor chip 10B illustrated in FIG. 5B includes the dielectric plate 11 and a metal fine structure body 74 provided on a predetermined area of the dielectric plate 11. The metal fine structure body 74 is formed by a metal pattern layer. In the metal pattern layer, metal thin wires 74a are arranged in grid form by pattern formation. The pattern of the metal pattern layer may be appropriately designed, and it is desirable that the pattern is substantially regular. This structure is designed in such a manner that an average width (line width) of the metal thin wires 74a and an average pitch thereof are smaller than the wavelength of the excitation light L₀.

A sensor chip 10C illustrated in FIG. 5C includes a metal fine structure body 75 as disclosed in U.S. Patent Application Publication No. 20070158549. The metal fine structure body 75 includes a plurality of mushroom-shape metals 75a that have grown in a plurality of minute pores (holes) 77a in a metal oxide object 77. The minute pores 77a are formed in the process of anodic oxidation of a metal 76, such as Al. Here, the metal oxide object 77 corresponds to the dielectric plate 11. The metal fine structure body 75 can be produced by obtaining a metal oxide object (Al₂O₃ or the like) by performing anodic oxidation on a part of a metal body (Al or the like) and by making the metal 75a grow in each of the plurality of minute pores 77a in the metal oxide object 77 by plating or the like.

In the example illustrated in FIG. 5C, the top portion of the mushroom-shape metal 75a has particle form. Therefore, when the metal fine structure body 75 is observed from the surface of the sample plate, the metal fine structure body 75 is structured in such a manner that metal microparticles are arranged. In this structure, the top portions of the mushroom-shape metals 75a are projections (projections in an uneven pattern), and the structure is designed in such a manner that an average diameter of the projections (top portions) and an average pitch thereof are smaller than the wavelength of excitation light L₀.

Further, as the metal layer 12′, which generates localized plasmons by irradiation with excitation light, various kinds of other metal fine structure bodies may be used. The various kinds of metal fine structure bodies utilize fine structures obtained by performing anodic oxidation on metal bodies, as disclosed in U.S. Patent Application Publication No. 20060234396, U.S. Patent Application Publication No. 20060181701, and the like.

Further, the metal layer that generates localized plasmons may be formed by a metal film (coating) the surface of which has been coarsened. As a method for coarsening the surface, there is an electro-chemical method utilizing oxidation/reduction or the like. Further, the metal layer may include a plurality of metal nanorods arranged on a sample plate. The short-axial length of the metal nanorods is approximately 3 nm to 50 nm, and the long-axial length of the metal nanorods is approximately 25 nm to 1000 nm. Further, the long-axial length should be less than the wavelength of the excitation light. The metal nanorods are disclosed, for example, in U.S. Patent Application Publication No. 20070118936, or the like.

Further, it is desirable that the metal fine structure body and the metal nanorods, which are used as the metal layer 12′, contain, as a main component, at least one kind of metal selected from the group consisting of Au, Ag, Cu, Al, Pt, Ni and Ti and alloys thereof.

Next, a fluorescence detection method of the present embodiment using the fluorescence detection apparatus 2 will be described.

The processes of preparing a sensor chip and carrying out antigen-antibody reaction are similar to the processes in the first embodiment. Therefore, the explanation about these processes will be omitted in the following embodiments.

A magnetic field is generated by the magnetic field application means 35 with the sensor chip 10′ set in the housing unit 19 to attract the magnetic microparticle M to the sensor portion 14. Further, a predetermined area of the dielectric plate 11 of the sensor chip 10 is irradiated with excitation light L₀ by the excitation light irradiation optical system 20 in a state in which the fluorescent substance F that includes the magnetic microparticle M is attracted to the sensor portion 14. The excitation light L₀ output from the light source 21 is reflected by the half mirror 23, and enters the sample contact surface of the sensor chip 10′. When the sensor chip 10′ is irradiated with the excitation light L₀, localized plasmons are excited on the surface of the metal layer 12′. An optical electric field (an electric field induced by near-field light) generated on the metal layer by entrance of the excitation light to the metal layer is enhanced by the localized plasmons, and an electric field enhanced region D is formed on the metal layer. Meanwhile, the fluorescent substance F containing the magnetic microparticle M has been attracted by the magnetic field application means 35 to the electric field enhanced region D, and the fluorescent dye molecules f contained in the fluorescent substance F are excited, and fluorescence L_{f} is output. The fluorescence L_{f} is detected by the photodetector 30. Accordingly, it is possible to detect the presence and/or the amount of the detection target substance that has bound to the fluorescent-label binding substance.

In the present embodiment, the magnetic microparticle M has been added to the fluorescent-label binding substance, and fluorescence is detected in a state in which the magnetic microparticle M is attracted to the sensor portion by the magnetic field application means, such as a magnet. Therefore, an effect similar to the effect of the first embodiment can be achieved.

### Third Embodiment

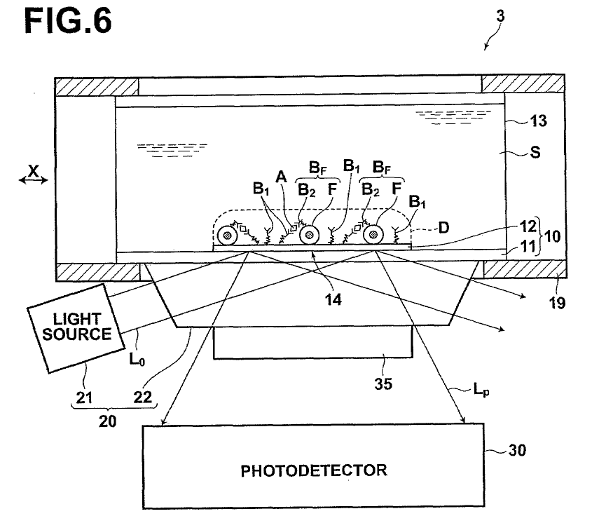

A detection method and apparatus according to a third embodiment will be described with reference to FIG. 6. FIG. 6 is a schematic diagram illustrating the structure of the detection apparatus of the third embodiment. The detection method and apparatus in this embodiment enhances an electric field by surface plasmon resonance, and fluorescence excited in the enhanced electric field newly induces plasmons in the metal layer. Further, light from the newly-induced plasmons radiates from the opposite surface of the dielectric plate, the opposite surface being opposite to the metal-layer-formation surface of the dielectric plate. Further, radiation light from the newly induced plasmons is detected in the radiation light detection method and apparatus of this embodiment.

In a radiation light detection apparatus 3, illustrated in FIG. 6, the arrangement of the fluorescence detection apparatus and the photodetector is different from the arrangement in the first embodiment. In the radiation light detection apparatus 3 of the present embodiment, the photodetector 30 is arranged in such a manner that radiation light Lₚ from the newly induced plasmons is detected. The plasmons are newly induced in the metal layer by fluorescence, and the radiation light Lₚ from the newly induced plasmons radiates from the opposite surface of the dielectric plate, the opposite surface being opposite to the metal layer formation surface of the dielectric plate.

A radiation light detection method of the present embodiment using the radiation light detection apparatus 3 will be described.

With the sensor chip 10 set in the housing unit 19, a magnetic field is generated by the magnetic field application means 35 to attract the magnetic microparticle M to the sensor portion 14 (or to the vicinity of the sensor portion). The magnetic microparticle M included in the fluorescent substance F is attracted to the sensor portion 14, and in this state, excitation light L₀ is output from the excitation light irradiation optical system 20 in a manner similar to the first embodiment. The excitation light irradiation optical system 20 outputs the excitation light L₀ in such a manner that the excitation light L₀ enters the interface between the dielectric plate 11 and the metal film 12 at a specific incident angle that is greater than or equal to a total reflection angle. When the excitation light L₀ enters the interface in such a manner, evanescent waves extend to the sample S on the metal film 12, and surface plasmons are excited in the metal film 12 by the evanescent waves. Further, the optical electric field (an electric field induced by evanescent waves) that has been generated on the metal layer by the incident excitation light is enhanced by the surface plasmons. Accordingly, electric field enhanced region D is formed on the metal layer. Since the fluorescent substance F including the magnetic microparticle M has been attracted to the electric field enhanced region D by the magnetic field application means 35, the fluorescent dye molecules f in the fluorescent substance F are excited, and fluorescence L_{f} is output. At this time, the fluorescence is enhanced by the electric field enhancement effect by the surface plasmons. The fluorescence L_{f} generated on the metal film 12 newly induces surface plasmons in the metal film 12, and radiation light Lₚ is output by the surface plasmons at a specific angle from an opposite surface of the sensor chip 10, the opposite surface being opposite to the metal film formation surface of the sensor chip 10. Further, the radiation light Lₚ is detected by the photodetector 30. Accordingly, it is possible to detect the presence and/or amount of the detection target substance that has bound to the fluorescent-label binding substance.

The radiation light Lₚ is generated when fluorescence is coupled to surface plasmons of a specific wavenumber in the metal film. The wavenumber of the surface plasmons that are coupled to the fluorescence is determined by the wavelength of the fluorescence. Further, the output angle of radiation light is determined by the wavenumber. Ordinarily, the wavelength of excitation light L₀ and the wavelength of fluorescence differ from each other. Therefore, the wavenumber of the surface plasmons excited by the fluorescence differs from that of the surface plasmons generated by the excitation light L₀. Therefore, the radiation light Lₚ is output at an angle different from the incident angle of the excitation light L₀.

In the present embodiment, the magnetic microparticle M has been added to the fluorescent-label binding substance, and fluorescence is output in a state in which the magnetic microparticle M is attracted to the sensor portion by the magnetic field application means, such as a magnet. Further, radiation light induced by the enhanced fluorescence is detected. Therefore, an effect similar to the effect of the first embodiment can be achieved.

Further, in the present embodiment, light caused by the fluorescence generated on the surface (front surface) of the sensor is detected from the back side of the sensor. Therefore, it is possible to reduce the distance of a solvent through which the fluorescence L_{f} passes (travels), and which greatly absorbs light, to approximately several tens nm. Therefore, it is possible to substantially ignore light absorption, for example, in blood. Therefore, it is possible to perform measurement without performing pre-processing, such as centrifuging the blood to remove a colored component, such as red blood cells, from the blood, and filtering the blood through a blood cell filter to obtain blood serum or blood plasma.

### Fourth Embodiment

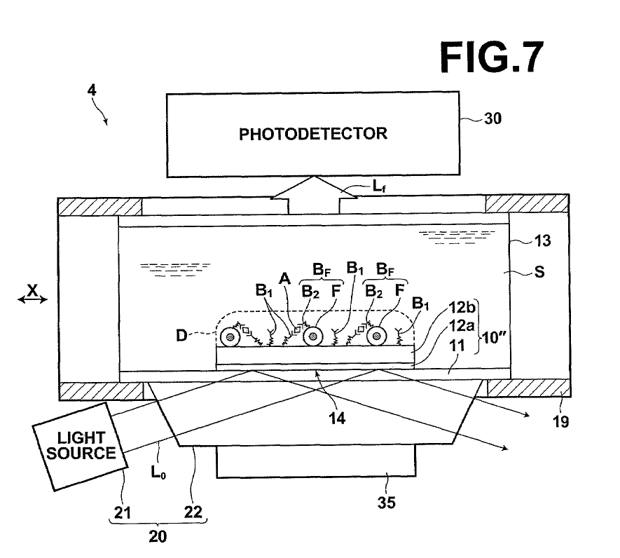

A detection method and apparatus according to a fourth embodiment will be described with reference to FIG. 7. FIG. 7 is a schematic diagram illustrating the structure of the whole detection apparatus of the fourth embodiment. The detection method and apparatus in this embodiment uses a sensor chip including an optical waveguide layer on the metal layer, and excites an optical waveguide mode in the optical waveguide layer by irradiation with excitation light. Further, an electric field is enhanced by the optical waveguide mode, and fluorescence is excited in the enhanced electric field to detect the fluorescence.

The structure of the fluorescence detection apparatus 4 illustrated in FIG. 7 is the same as the structure of the fluorescence detection apparatus of the first embodiment. However, the sensor chip used in the present embodiment differs from the sensor chip used in the first embodiment. Therefore, the mechanism of enhancing the electric field in the present embodiment differs because of the difference in the sensor chip.

A sensor chip 10″ includes an optical waveguide layer 12b on the metal layer 12a. The thickness of the optical waveguide layer 12b is not particularly limited. The thickness of the optical waveguide layer 12b may be determined so that the optical waveguide mode is induced by considering the wavelength of the excitation light L₀, the incident angle of the excitation light L₀, the refractive index of the optical waveguide layer 12b, and the like. For example, when a laser beam that has a center wavelength of 780 nm is used as the excitation light L₀ in a manner similar to the aforementioned example, and the optical waveguide layer 12b made of a single layer of silicon oxide film is used, it is desirable that the thickness of the optical waveguide layer 12b is approximately in the range of 500 to 600 nm. Further, the optical waveguide layer 12b may have layered structure including at least a layer of internal optical waveguide layer made of an optical waveguide material, such as a dielectric. It is desirable that the layered structure is an alternately-layered structure in which an internal optical guide layer and an internal metal layer are sequentially deposited from the metal layer side.

A fluorescence detection method according to the present embodiment using the fluorescence detection apparatus 4 will be described.

With the sensor chip 10″ set in the housing unit 19, a magnetic field is generated by the magnetic field application means 35 to attract the magnetic microparticle M to the sensor portion 14. In a state in which the fluorescent substance F is attracted to the sensor portion 14 as described above, excitation light L₀ is output from the excitation light irradiation optical system 20 in a manner similar to the first embodiment. The excitation light irradiation optical system 20 outputs the excitation light L₀ in such a manner that the excitation light L₀ enters the interface between the dielectric plate 11 and the metal layer 12a at a specific incident angle that is greater than or equal to a total reflection angle. When the excitation light L₀ enters the interface in such a manner, evanescent waves extend to the surface of the metal layer 12a, and the evanescent waves are coupled to the optical waveguide mode of the optical waveguide layer 12b, and the optical waveguide mode is excited. The optical electric field (an electric field induced by evanescent waves) that has been generated on the optical waveguide layer by the incident excitation light is enhanced by the optical waveguide mode. Accordingly, electric field enhanced region D is formed on the optical waveguide layer. Since the fluorescent substance F including the magnetic microparticle M has been attracted to the electric field enhanced region D by the magnetic field application means 35, when the fluorescent dye molecules f in the fluorescent substance F are excited, fluorescence L_{f} is output. At this time, the fluorescence is enhanced by the electric field enhancement effect by the optical waveguide mode. The fluorescence L_{f} is detected by the photodetector 30. Accordingly, it is possible to detect the presence and/or amount of the detection target substance that has bound to the fluorescent-label binding substance.

In the present embodiment, the magnetic microparticle M has been added to the fluorescent-label binding substance, and fluorescence is detected in a state in which the magnetic microparticle M is attracted to the sensor portion by the magnetic field application means, such as a magnet. Therefore, an effect similar to the effect of the first embodiment can be achieved.

Further, in the distribution of electric field generated by excitation of the optical waveguide mode, the degree of attenuation of the electric field according to the distance from the surface is small, compared with the degree of attenuation in the distribution of electric field generated by surface plasmons. Therefore, when a fluorescent substance that has a large diameter, and which includes a plurality of fluorescent dye molecules, is used as the fluorescent label, a greater fluorescent amount increase effect is achieved in enhancement of the electric field by the optical waveguide mode, compared with enhancement of the electric field by surface plasmons.

### Fifth Embodiment

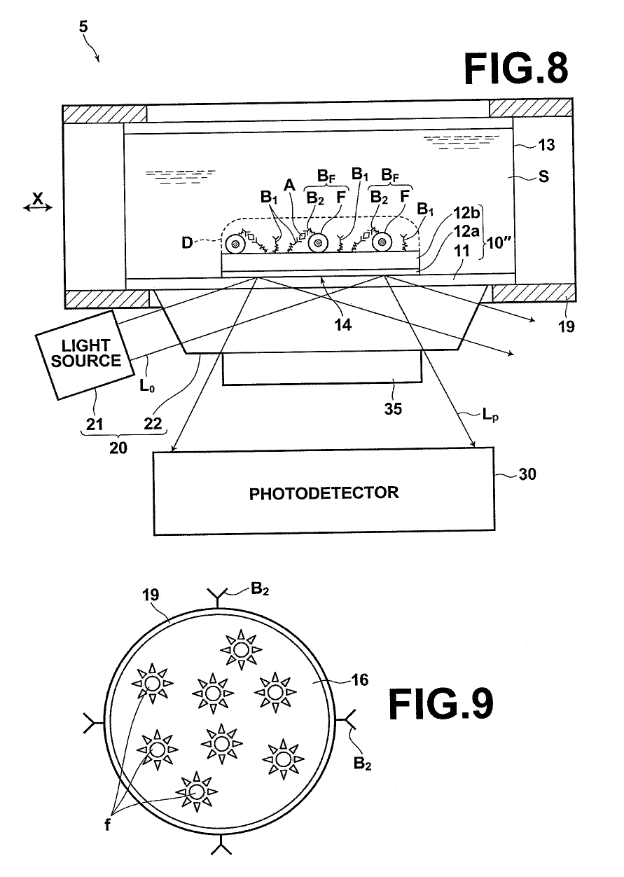

A detection method and apparatus according to a fifth embodiment will be described with reference to FIG. 8. FIG. 8 is a schematic diagram illustrating the structure of the whole detection apparatus of the fifth embodiment. The detection method and apparatus in this embodiment uses a sensor chip including an optical waveguide layer on the metal layer, and excites an optical waveguide mode in the optical waveguide layer by irradiation with excitation light. Further, an electric field is enhanced by the optical waveguide mode, and fluorescence is excited in the enhanced electric field to newly induce plasmons in the metal layer. Consequently, radiation light from the newly induced plasmons radiates from the opposite surface of the dielectric plate, the opposite surface being opposite to the metal layer formation surface of the dielectric plate. In the detection method and apparatus according to the fifth embodiment, the radiation light is detected.

The structure of the radiation light detection apparatus 5 illustrated in FIG. 8 is similar to the radiation light detection apparatus of the third embodiment. The sensor chip used in the detection method of the present embodiment is similar to the sensor chip used in the fluorescence detection method of the fourth embodiment.

A fluorescence detection method according to the present embodiment using the radiation light detection apparatus 5 will be described.

With the sensor chip 10″ set in the housing unit 19, a magnetic field is generated by the magnetic field application means 35 to attract the magnetic microparticle M to the sensor portion 14. In a state in which the fluorescent substance F including the magnetic microparticle M is attracted to the sensor portion 14 as described above, excitation light L₀ is output from the excitation light irradiation optical system 20 in a manner similar to the first embodiment. The excitation light irradiation optical system 20 outputs the excitation light L₀ in such a manner that the excitation light L₀ enters the interface between the dielectric plate 11 and the metal layer 12a at a specific incident angle that is greater than or equal to a total reflection angle. When the excitation light L₀ enters the interface in such a manner, evanescent waves extend to the surface of the metal layer 12a, and the evanescent waves are coupled to the optical waveguide mode of the optical waveguide layer 12b, and the optical waveguide mode is excited. Further, the optical electric field (an electric field induced by evanescent waves) that has been generated on the optical waveguide layer by the incident excitation light is enhanced by the optical waveguide mode. Accordingly, electric field enhanced region D is formed on the optical waveguide layer. Since the fluorescent substance F including the magnetic microparticle M has been attracted to the electric field enhanced region D by the magnetic field application means 35, the fluorescent dye molecules f in the fluorescent substance F are excited, and fluorescence L_{f} is output. The fluorescence is enhanced by the electric field enhancement effect by the optical waveguide mode. The fluorescence L_{f} generated on the optical waveguide layer 12b newly induces surface plasmons in the metal film 12, and radiation light Lₚ is output by the surface plasmons at a specific angle from an opposite surface of the sensor chip 10, the opposite surface being opposite to the metal film formation surface. Further, the radiation light Lₚ is detected by the photodetector 30. It is possible to detect the presence and/or amount of the detection target substance labeled with the fluorescent label F.

In the present embodiment, the magnetic microparticle M has been added to the fluorescent-label binding substance, and fluorescence is detected in a state in which the magnetic microparticle M is attracted to the sensor portion by the magnetic field application means, such as a magnet. Therefore, an effect similar to the effect of the first embodiment can be achieved.

Further, in the present embodiment, light induced by the fluorescence generated on the surface (front surface) of the sensor is detected from the back side of the sensor. Therefore, it is possible to reduce the distance of a solvent through which the fluorescence L_{f} passes, and which greatly absorbs light, to approximately several tens nm. Hence, it is possible to achieve an effect similar to the second embodiment.

Further, since the electric field enhancement by excitation of the optical waveguide mode is used, it is possible to achieve a fluorescent amount increase effect similar to the fourth embodiment.

As illustrated in FIG. 9, a metal coating 19 may be further provided on the surface of the material 16. The thickness of the metal coating 19 should be sufficiently thin to transmit fluorescence. The metal coating 19 may be provided on the entire surface of the material 16. Alternatively, the metal coating 19 may be provided in such a manner that a part of the surface of the material 16 is exposed. As the material of the metal coating 19, a metal material similar to the aforementioned material of the metal layer may be used.

When the metal coating 19 is provided on the surface of the fluorescent substance, the surface plasmons or localized plasmons generated in the metal layers 12, 12′ of the sensor chips 10, 10′ couple to a whispering gallery mode of the metal coating 19 of the fluorescent substance F. Therefore, it is possible to more efficiently excite the fluorescent dye molecules f in the fluorescent substance F. The whispering gallery mode is an electromagnetic mode that is localized on the spherical surface of a micro-sphere of approximately φ5300 nm or less, such as the fluorescent substance that is used here, and that travels around the spherical surface of the micro-sphere.

An example of a method for applying the metal coating to the fluorescent substance will be described.

First, an anti-quenching fluorescent substance is produced through the aforementioned procedure. Further, the surface of the anti-quenching fluorescent substance is modified with polyethyleneimine (PEI) (EPOMIN, produced by NIPPON SHOKUBAI CO., LTD.).

Next, Pd nano particles having a diameter of 15 nm (average particle diameter of 19 nm, produced by TOKURIKI-HONTEN) is adsorbed by the PEI on the surface of the particle.

The polystyrene particle that has adsorbed the Pd nano particles is impregnated in electroless gold plating solution (HAuCl₄, produced by Kojima Chemicals, Co., LTD.). Accordingly, a gold coating is deposited on the surface of the polystyrene particle by electroless plating using Pd nano particles as a catalyst.

### “Sample Cell for Detection”

A sample cell for detection that is used as a sensor chip in the detection method of the present invention will be described.

### <Sample Cell of First Embodiment>

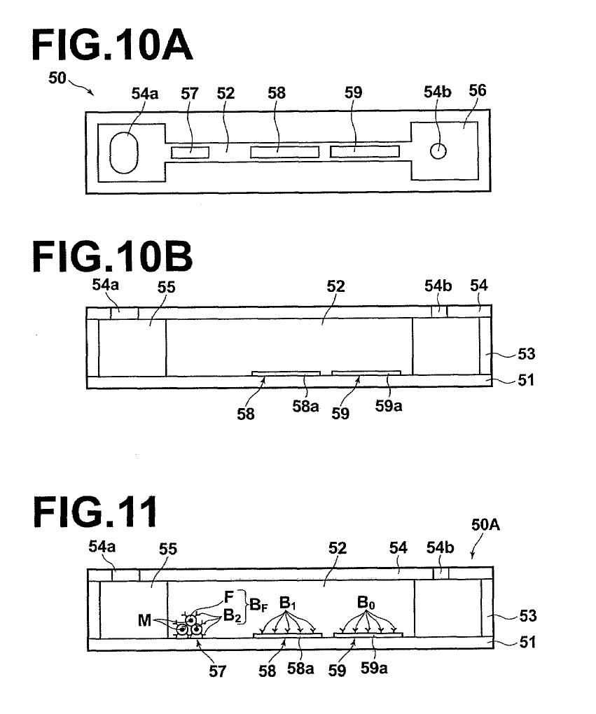

FIG. 10A is a plan view illustrating the structure of a sample cell 50 according to a first embodiment. FIG. 10B is a sectional side view of the sample cell 50.

The sample cell 50 for detection includes a base (substrate) 51, a spacer 53, and an upper plate 54. The base 51 is formed by a dielectric plate. The spacer 53 retains liquid sample S on the base 51, and forms a flow path 52 of the liquid sample S. The upper plate 54 is formed by a glass plate that has an injection opening 54a for injecting the sample S and an air hole 54b for discharging the sample that has flowed through the flow path 52. Further, sensor portions 58, 59 formed by metal layers 58a, 59a are provided in predetermined areas on the sample contact surface of the base 51. The sensor portions 58, 59 are provided between the injection opening 54a and the air hole 54b of the flow path 52. Further, a membrane filter 55 is provided in a portion of the sample cell 50 from the injection opening 54 to the flow path 52. Further, a waste liquid reservoir 56 is provided on the downstream side of the flow path 52. The waste liquid reservoir 56 is connected to the air hole 54b.

In the present embodiment, the base 51 is formed by the dielectric plate, and the base 51 also functions as the dielectric plate of the sensor portion. Alternatively, only a part of the base, the part constituting the sensor portions, may be formed by the dielectric plate.

The sample cell 50 may be used as a sensor chip in any of the detection apparatuses and method in the first through fifth embodiments in a similar manner.

The sample cell 50 for detection of the present invention may be used by appropriately immobilizing, based on the detection target substance, a first binding substance that specifically binds to the detection target substance in the sensor portion.

Further, the sample cell 50 for detection may be used by appropriately immobilizing a fluorescent-label binding substance at a position that is on the upstream side of the sensor portions in the flow path. The fluorescent-label binding substance includes one of a second binding substance that specifically binds to the detection target substance and a third binding substance that competes with the detection target substance and specifically binds to the first binding substance and a fluorescent label that is modified with the one of the binding substances. Further, a magnetic microparticle has been added to the fluorescent-label binding substance.

### <Sample Cell According to Second Embodiment>

FIG. 11 is a sectional side view illustrating a sample cell of the second embodiment that is suitable for an assay by using a sandwich method. In a sample cell 50A of the present embodiment, a labeling secondary antibody adsorption area 57, a first measurement area 58, and a second measurement area 59 are sequentially formed on the base 51 from the upstream side of the flow path 52. In the labeling secondary antibody adsorption area 57, a fluorescent-label binding substance B_{F} (hereinafter, referred to as “labeling secondary antibody B_{F}”) has been physically adsorbed. The fluorescent-label binding substance B_{F} contains the secondary antibody (second binding substance) B₂ that specifically binds to the antigen, which is the detection target substance, and anti-quenching fluorescent substance F, the surface of which is modified with the secondary antibody B₂. In the first measurement area 58, a primary antibody (first binding substance) B₁ is immobilized. The primary antibody B₁ specifically binds to the antigen, which is the detection target substance. In the second measurement area 59, a primary antibody B₀ is immobilized. The primary antibody B₀ does not bind to the antigen A, which is the detection target substance, but specifically binds to the secondary antibody B₂. The first measurement area 58 and the second measurement area 59 correspond to the sensor portion. In this example, two measurement areas are provided in the sensor portion. Alternatively, only one measurement area may be provided. Further, a magnetic microparticle M has been added to the fluorescent-label binding substance B_{F}. The magnetic microparticle M may be added in any one of manners illustrated in FIGS. 2A through 2D, which have been described already. Here, it is assumed that the magnetic microparticle M is included in the fluorescent substance F as illustrated in FIG. 2D.

In the first measurement area 58, a gold (Au) layer 58a, as a metal layer, is formed on the base 51. In the second measurement area 59, a gold (Au) layer 59a, as a metal layer, is formed on the base 51. Further, primary antibody B₁ is immobilized on the Au layer 58a of the first measurement area 58, and primary antibody B₀, which is different from the primary antibody B₁, is immobilized on the Au layer 59a of the second measurement area 59. The first measurement area 58 and the second measurement area 59 are structured in the same manner except that the immobilized primary antibodies differ from each other. The primary antibody B₀, which is immobilized in the second measurement area 59, does not bind to antigen A, but directly binds to secondary antibody B₂. Accordingly, it is possible to detect fluctuation factors related to reaction, such as the amount or activity of the labeling secondary antibody B_{F} that has flowed through the flow path. Further, it is possible to detect fluctuation factors related to the degree of enhancement of the electric field, such as the excitation light irradiation optical system 20, the gold (Au) layers 58a, 59a, and the liquid sample S. Further, the detected fluctuation factors can be used for calibration. It is not necessary that the primary antibody B₀ is immobilized in the second measurement area 59. Instead of the primary antibody B₀, a known amount of labeling substance may be immobilized in the second measurement area 59 in advance. The labeling substance may be the same kind of substance as the fluorescent substance F of the labeling secondary antibody B_{F}. Alternatively, the labeling substance may be a fluorescent substance that has a different wavelength and size from the fluorescent substance F of the labeling secondary antibody B_{F}. Further, the labeling substance may be a metal microparticle and the like. In this case, only the fluctuation factors related to the degree of enhancement of surface plasmons, such as the excitation light irradiation optical system 20, the gold (Au) layers 58a, 59a, and the liquid sample S, may be detected to use the detected factors for calibration. Whether the labeling secondary antibody B_{F} or the known amount of labeling substance is immobilized in the second measurement area 59 may be appropriately determined based on the purpose and method of calibration.

The sample cell 50A may be used instead of the sensor chip in any of the detection apparatuses and methods of the first through fifth embodiments in a similar manner. The sample cell 50A can move in X direction relative to the excitation light irradiation optical system 20 and the photodetector 30. After fluorescence or radiation light from the first measurement area 58 is detected and measured, the second measurement area 59 is moved to the detection position, and fluorescence or radiation light from the second measurement area 59 is detected.

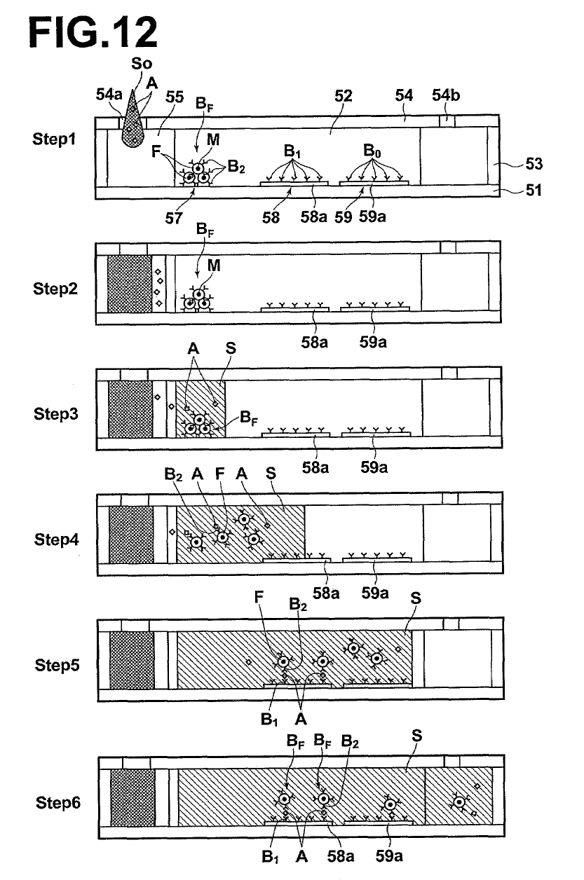

With reference to FIG. 12, assay procedures by using a sandwich method will be described. In the assay procedures, whether blood (whole blood) contains an antigen, which is a detection target substance, is detected by using the sample cell 50A of the present embodiment.

Step 1: Blood (whole blood) Sₒ, which is the assay target (examination target), is injected from the injection opening 54a. Here, a case in which the antigen that is the detection target substance is included in the blood Sₒ will be described. In FIG. 12, the whole blood Sₒ is indicated by a mesh.

Step 2: The whole blood Sₒ is filtered by the membrane filter 55, and large molecules, such as erythrocyte (red blood cells) and leukocyte (white blood cells), remain as a residue.

Step 3: Blood (plasma, blood plasma) S after blood cells (blood corpuscles) are removed by the membrane filter 55 penetrates into the flow path 52 by a capillary action. Alternatively, a pump may be connected to the air hole 54b to accelerate reaction, thereby reducing detection time. The pump sucks the blood after blood cells are removed by the membrane filter 55 and pumps (pressures to discharge) the sucked blood, thereby causing the blood to flow down through the path. In FIG. 12, the blood plasma S is indicated by a shadow.

Step 4: The blood plasma S that has penetrated into the flow path 52 and the labeling secondary antibody B_{F} are mixed together. Accordingly, antigen A in the blood plasma and the secondary antibody B₂ of labeling secondary antibody B_{F} bind to each other.

Step 5: The blood plasma S gradually flows down to the air hole 54b side along the flow path 52. The antigen A that has bound to the labeling secondary antibody B_{F} binds to the primary antibody B₁ that has been immobilized in the first measurement area 58. Accordingly, a so-called sandwich is formed, in which the antigen A is sandwiched between the primary antibody B₁ and the secondary antibody B₂ (labeling secondary antibody B_{F}).

Step 6: A part of the labeling secondary antibody B_{F} that has not bound to the antigen A binds to the primary antibody B₀ immobilized on the second measurement area 59. Further, even if the labeling secondary antibody B_{F} that has bound neither to the antigen A nor to the primary antibody B₀ remains in the measurement areas, the blood plasma flowing next functions as washing liquid, and washes away floating or non-specifically-adsorbed labeling secondary antibody.

As described above, in Steps 1 through 6, the blood is injected from the injection opening and a sandwich in which the antigen A is sandwiched between the primary antibody B₁ and the secondary antibody B₂ is formed on the measurement area 58. After Steps 1 through 6, the intensity of fluorescence or radiation light (hereinafter, referred to as “signal”) from the first measurement area 58 is detected, thereby detecting the presence and/or the concentration of the antigen. After then, the sample cell 50 is moved in X direction so that the signal from the second measurement area 59 can be detected, and the signal from the second measurement area 59 is detected. The signal from the second measurement area 59 in which the primary antibody B₀ that binds to the labeling secondary antibody B_{F} is immobilized reflects reaction conditions, such as the amount and the activity of the labeling secondary antibody that has flowed down. Therefore, if this signal is used as a reference (reference signal) and the signal from the first measurement area is corrected based on the reference, it is possible to obtain a more accurate detection result. Further, even when a known amount of labeling substance (fluorescence substance and metal particle) is immobilized in advance in the second measurement area 59, as described above already, it is possible to use the signal from the second measurement area 59 as a reference in a similar manner, and the signal from the first measurement area can be corrected based on the reference.

### <Sample Cell According to Third Embodiment>

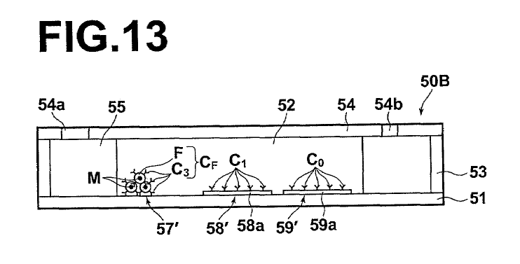

FIG. 13 is a diagram illustrating a sample cell of the third embodiment that is suitable for an assay by using a competition method. In a sample cell 50B of the present embodiment, a labeling secondary antibody adsorption area 57′, a first measurement area 58′, and a second measurement area 59′ are sequentially formed on the base 51 of the sample cell 50B from the upstream side of the flow path 52. In the labeling secondary antibody adsorption area 57′, a fluorescent-label binding substance C_{F} (hereinafter, referred to as “labeling secondary antibody C_{F}”) has been physically adsorbed. The fluorescent-label binding substance C_{F} contains the secondary antibody (third binding substance) C₃ that does not bind to the antigen A, which is the detection target substance, and that specifically binds to the primary antibody, which will be described later, and the anti-quenching fluorescent substance the surface of which is modified with the secondary antibody C₃. In the first measurement area 58′, the antigen A, which is the detection target substance, and a primary antibody (first binding substance) C₁ are immobilized. The primary antibody C₁ specifically binds to the antigen A and the secondary antibody C₃. In the second measurement area 59′, a primary antibody C₀ is immobilized. The primary antibody C₀ does not bind to the antigen A, which is the detection target substance, but specifically binds to the secondary antibody C₃ of the labeling secondary antibody C_{F}. Further, a magnetic microparticle M has been added to the fluorescent-label binding substance C_{F}. The magnetic microparticle M may be added in any one of manners illustrated in FIGS. 2A through 2D, which have been described already. Here, it is assumed that the magnetic microparticle M is included in the fluorescent substance F as illustrated in FIG. 2D.

In the first measurement area 58′, a gold (Au) layer 58a, as a metal layer, is formed on the base 51. In the second measurement area 59′, a gold (Au) layer 59a, as a metal layer, is formed on the base 51. Further, primary antibody C₁ is immobilized on the Au layer 58a of the first measurement area 58′, and primary antibody C₀, which is different from the primary antibody C₁, is immobilized on the Au layer 59a of the second measurement area 59′. The first measurement area 58′ and the second measurement area 59′ are structured in the same manner except that the immobilized primary antibodies differ from each other. The antigen A and the secondary antibody C₃ compete with each other and bind to the primary antibody C, that is immobilized in the first measurement area 58′. The primary antibody C₀ immobilized in the second measurement area 59′ does not bind to antigen A, but directly binds to secondary antibody C_{F}. Accordingly, it is possible to detect fluctuation factors related to reaction, such as the amount and activity of the labeling secondary antibody that has flowed through the flow path. Further, it is possible to detect fluctuation factors related to the degree of enhancement of the electric field, such as the excitation light irradiation optical system 20, the gold (Au) layers 58a, 59a, and the liquid sample S. Further, the detected fluctuation factors can be used for calibration. It is not necessary that the primary antibody C₀ is immobilized in the second measurement area 59′. Instead of the primary antibody C₀, a known amount of labeling substance may be immobilized in the second measurement area 59′ in advance. The labeling substance may be the same kind of substance as the fluorescent substance F of the labeling secondary antibody C_{F}. Alternatively, the labeling substance may be a fluorescent substance that has a different wavelength and size from the fluorescent substance F of the labeling secondary antibody C_{F}. In this case, only the fluctuation factors related to the degree of enhancement of surface plasmons, such as the excitation light irradiation optical system 20, the gold (Au) layers 58a, 59a, and the liquid sample S, may be detected to be used for calibration. Whether the labeling secondary antibody C_{F} or the known amount of labeling substance is immobilized in the second measurement area 59′ may be appropriately determined based on the purpose and method of calibration.

The sample cell 50B may be used instead of the sensor chip in any of the detection apparatuses and methods of the first through fifth embodiments in a manner similar to the sample cell 50A.

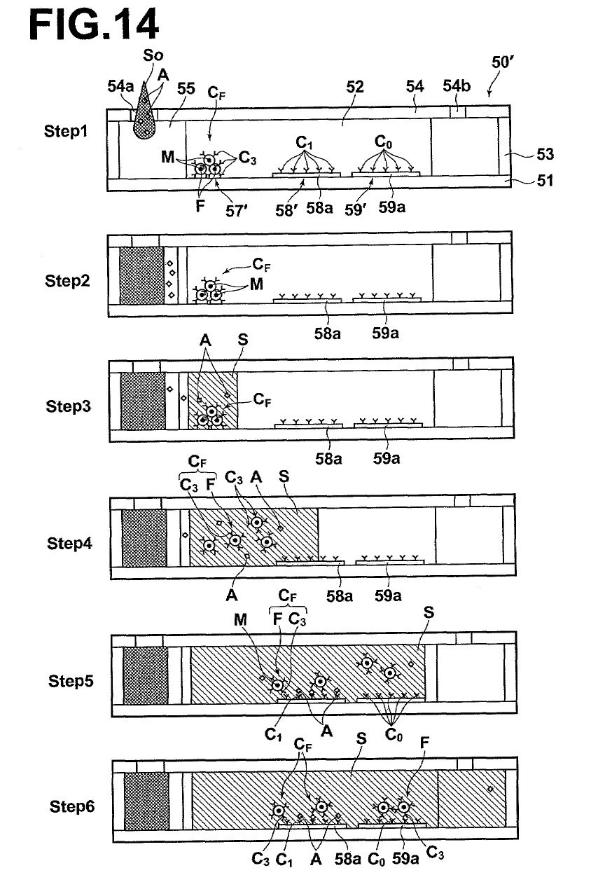

With reference to FIG. 14, assay procedures by using a sandwich method will be described. In the assay procedures, the sample cell 50B for detection of the present embodiment is used, and an assay is performed as to whether an antigen, which is a detection target substance, is included in the blood (whole blood).

Step 1: Blood (whole blood) Sₒ, which is the assay target, is injected from an injection opening 54a. Here, a case in which the antigen that is the detection target substance is included in the blood Sₒ will be described. In FIG. 14, the whole blood Sₒ is indicated by a mesh.

Step 2: The whole blood Sₒ is filtered by a membrane filter 55, and large molecules, such as erythrocyte (red blood cells) and leukocyte (white blood cells), remain as the residue.

Step 3: The blood (plasma, blood plasma) S after blood cells are removed by the membrane filter 55 penetrates into the flow path 52 by a capillary action. Alternatively, a pump may be connected to the air hole 54b to accelerate reaction, thereby reducing detection time. The pump sucks the blood after blood cells are removed by the membrane filter 55 and pumps the sucked blood, thereby causing the blood to flow down through the path. In FIG. 14, the blood plasma S is indicated by a shadow.

Step 4: The blood plasma S that has penetrated into the flow path 52 and the labeling secondary antibody C_{F} are mixed together.

Step 5: The blood plasma S gradually flows to the air hole 54b side along the flow path 52. The antigen A and the secondary antibody C₃ of the labeling secondary antibody C_{F} competitively bind to the primary antibody C₁ that has been immobilized on the first measurement area 58′.

Step 6: A part of the fluorescence labeling secondary antibody C_{F} that has not bound to the primary antibody C₁ on the first measurement area 58′ binds to the primary antibody C₀ immobilized on the second measurement area 59′. Further, even if the labeling secondary antibody C_{F} that has bound neither to the primary antibody C₁ nor to the primary antibody C₀ remains on the measurement areas, the blood plasma S flowing next functions as washing liquid, and washes away a floating or non-specifically-adsorbed labeling secondary antibody C_{F}.

As described above, in Steps 1 through 6, the blood is injected from the injection opening and the antigen A and the secondary antibody C₃ competitively bind to the primary antibody C₁ on the first measurement area 58′. After Steps 1 through 6, the intensity of fluorescence or radiation light from the first measurement area 58′ and the second measurement area 59′ are detected, thereby obtaining the presence and/or the concentration of the antigen. The sample cell 50 is moved in X direction so that the signal from the second measurement area 59′ can be detected, and the signal from the second measurement area 59′ is detected. The signal from the second measurement area 59′ is used as reference, and the signal from the first measurement area is corrected. Hence, it is possible to obtain an accurate measurement result.

In the fluorescence detection method using the sample cell of the present embodiment, the anti-quenching fluorescent substance is used as the fluorescent label. Therefore, it is possible to achieve a similar effect to the aforementioned embodiments. Further, it is possible to perform accurate measurement by using a simple method.

In the competition method, when the concentration of the detection target substance A is higher, the amount of the third bonding substance C₃ that binds to the first binding substance C, decreases. Specifically, since the number of particles of the fluorescent substance F on the metal layer becomes smaller, the intensity of fluorescence becomes lower. In contrast, when the concentration of the detection target substance A is lower, the amount of the third bonding substance C₃ that binds to the first binding substance C₁ increases. Specifically, since the number of particles of the fluorescent substance F on the metal layer becomes larger, the intensity of fluorescence becomes higher. In the competition method, measurement is possible if at least one epitope is present in the detection target substance. Therefore, the competition method is suitable to detect a substance that has low molecular weight.

### (Design Modification Example of Sample Cell)

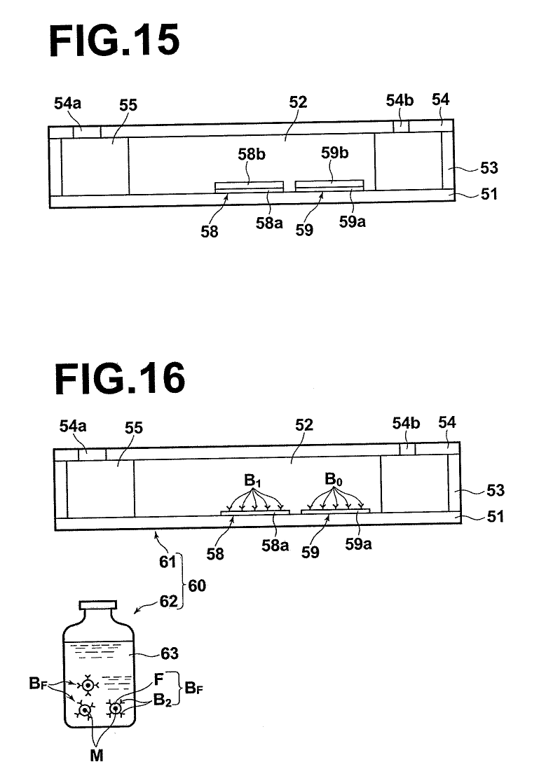

FIG. 15 is a diagram illustrating a sectional view of a sample cell used in the detection method and apparatus using electric field enhancement by an optical waveguide mode. The structure of the sample cell illustrated in FIG. 15 is substantially the same as the structure of the sample cell of the first embodiment, illustrated in FIGS. 10A and 10B. However, in FIG. 15, optical waveguide layers 58b, 59b are further provided on the metal layers 58a, 59a in the sensor portion.

This sample cell may be used by appropriately immobilizing a first binding substance in the sensor portion and a fluorescent-label binding substance on the upstream side of the sensor portion.

### “Kit for Detection”

A kit for detection used in the detection method of the present invention will be described.

FIG. 16 is a schematic diagram illustrating the structure of a kit 60 for detecting fluorescence.

The kit 60 for detection includes a sample cell 61 and a solution 63 for labeling, which is injected into the flow path of the sample cell 61 together with the liquid sample or after the liquid sample flows down to perform fluorescence detection measurement. The solution 63 for labeling contains fluorescent-label binding substance B_{F} (hereinafter, referred to as “labeling secondary antibody B_{F}”) containing secondary antibody (second binding substance) B₂ that specifically binds to the antigen A and anti-quenching fluorescent substance F the surface of which has been modified with the secondary antibody B₂. Further, the magnetic microparticle M has been added to the fluorescent-label binding substance B_{F}. The magnetic microparticle M may be added in any one of manners illustrated in FIGS. 2A through 2D, which have been described already. Here, it is assumed that the magnetic microparticle M is included in the fluorescent substance F as illustrated in FIG. 2D.

The sample cell 61 differs from the sample cell 50A of the second embodiment only in that a physical adsorption area, in which fluorescent-label binding substance B_{F} to which the magnetic microparticle has been added is physically adsorbed, is not provided in the sample cell 61. The remaining structure of the sample cell 61 is substantially the same as the structure of the sample cell 50A of the second embodiment.

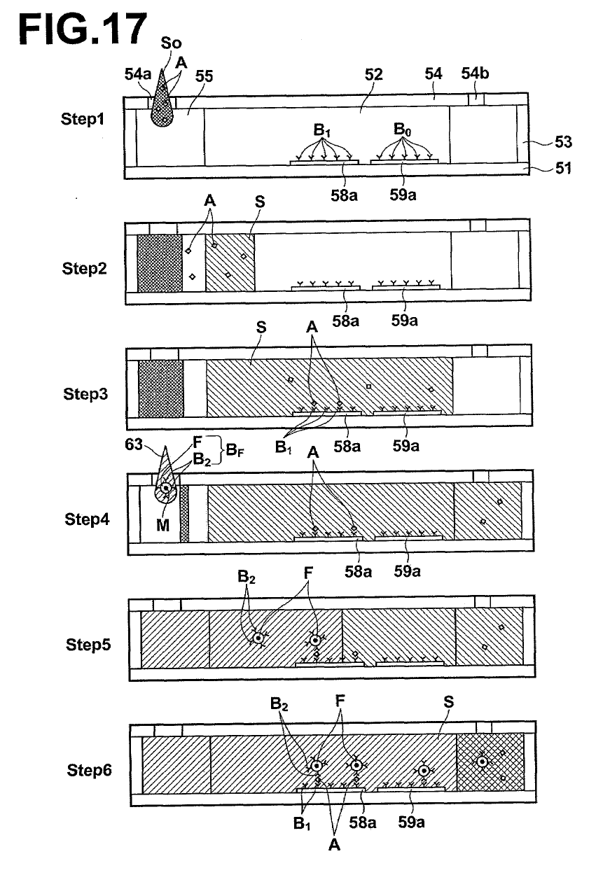

With reference to FIG. 17, assay procedures by using a sandwich method will be described. In the assay procedures, the kit 60 for detection of the present embodiment is used, and an assay is performed as to whether the blood (whole blood) contains an antigen, which is the detection target substance.

Step 1: Blood (whole blood) Sₒ, which is the assay target, is injected from an injection opening 54a. Here, a case in which the antigen that is the substance to be detected is contained in the blood Sₒ will be described. In FIG. 17, the whole blood Sₒ is indicated by a mesh.

Step 2: The whole blood Sₒ is filtered by the membrane filter 55, and large molecules, such as erythrocyte (red blood cells) and leukocyte (white blood cells), remain as a residue. Then, the blood (plasma, blood plasma) S after blood cells are removed by the membrane filter 55 penetrates into the flow path 52 by a capillary action. Alternatively, a pump may be connected to the air hole to accelerate reaction, thereby reducing detection time. The pump sucks the blood after blood cells are removed by the membrane filter 55 and pumps the sucked blood, thereby causing the blood to flow down through the path. In FIG. 17, the blood plasma S is indicated by a shadow.

Step 3: The blood plasma S gradually flows to the air hole 54b side along the flow path 52. The antigen A in the blood plasma S binds to the primary antibody B₁ that has been immobilized in the first measurement area 58.

Step 4: a solution 63 for labeling is injected from the injection opening 54a. The solution 63 for labeling contains labeling secondary antibody B_{F} to which the magnetic microparticle M has been added.

Step 5: the labeling secondary antibody B_{F} penetrates into the flow path 52 by a capillary action. Alternatively, a pump may be connected to the air hole to accelerate reaction, thereby reducing detection time. The pump sucks the blood after blood cells are removed by the membrane filter 55 and pumps the sucked blood, thereby causing the blood to flow down through the path.

Step 6: The labeling secondary antibody B_{F} gradually flows down to the downstream side, and the secondary antibody B₂ of the labeling secondary antibody B_{F} binds to the antigen A. Consequently, a so-called sandwich in which the antigen A is sandwiched between the primary antibody B₁ and the secondary antibody B₂ is formed. Further, a part of the secondary antibody B₂ that has not bound to the antigen A binds to the primary antibody B₀ immobilized on the second measurement area 59. Further, even if the labeling secondary antibody B_{F} that has bound neither to the antigen A nor to the primary antibody B₀ remains in the measurement areas, the blood plasma S flowing next functions as washing liquid, and washes away floating or non-specifically-adsorbed labeling secondary antibody on the plate.

As described above, in Steps 1 through 6, the blood is injected from the injection opening and the antigen binds to the primary antibody and the secondary antibody. After Steps 1 through 6, in the detection apparatus, a magnetic field is applied by a magnetic field application means to attract the fluorescent substance F onto the sensor portion, and a signal from the first measurement area 58 is detected. Accordingly, the presence of the antigen and/or the concentration of the antigen can be detected. After then, the sample cell 61 is moved in X direction so that the signal from the second measurement area 59 can be detected. At the same time, the fluorescent substance F is attracted onto the sensor portion in a similar manner, and the signal from the second measurement area 59 is detected. The signal from the second measurement area 59 in which the primary antibody B₀ that binds to the labeling secondary antibody B_{F} is immobilized reflects reaction conditions, such as the amount and activity of the labeling secondary antibody that has flowed down. Therefore, if this signal is used as a reference (reference signal) and the signal from the first measurement area is corrected based on the reference, it is possible to obtain a more accurate detection result. Further, a known amount of labeling substance (fluorescent substance and metal particle) may be immobilized in advance in the second measurement area 59, and the fluorescence signal from the second measurement area 59 may be used as a reference to correct the signal from the first measurement area 58 based on the reference.

An example of a method for modifying the anti-quenching fluorescent substance with the secondary antibody and an example of a method for producing a solution for labeling will be described.

A polymer particle (for example, M1-030/40, ferrite-containing polyethylene beads produced by MORITEX Corporation, φ˜400 nm) is used, and a fluorescent dye is impregnated into the polymer portion. Accordingly, a fluorescent substance F that includes the magnetic microparticle M and the fluorescent dye molecules f is prepared. The fluorescent substance F including the magnetic microparticle M and the fluorescent dye molecules f is added to a solution containing 50 mM of MES buffer and an anti-hCG monoclonal antibody of 5.0 mg/mL (Anti-hCG 5008 SP-5, Medix Biochemica), and stirred. Accordingly, the fluorescent substance is modified with the antibody.

Further, a WSC aqueous solution of 400 mg/mL (No. 01-62-0011, Wako Pure Chemical Industries, Ltd.) is added, and stirred at a room temperature.

Further, a Glycine aqueous solution of 2 mol/L is added, and stirred. Then, particles are precipitated by centrifugation.

Finally, the supernatant is removed, and PBS (pH 7.4) is added. An ultrasonic wash machine is used to redisperse the fluorescent substance F that includes the magnetic microparticle M and the fluorescent dye molecules f. Further, centrifugation is performed, and the supernatant is removed. Then, 500 μL of PBS (pH 7.4) solution of 1% BSA is added, and the fluorescent substance F is redispersed to obtain a solution for labeling.

### (Design Modification Example of Kit for Examination)

As the sample cell that is used in the detection method and apparatus using the electric field enhancement by an optical waveguide mode, the sample cell as illustrated in FIG. 15 may be used. In the sample cell illustrated in FIG. 15, optical waveguide layers 58b, 59b are further provided on the metal layers 58a, 59a of the sensor portion. Further, the primary antibody B₁ and the primary antibody B₀, which is different form the primary antibody B₀, are immobilized on the optical waveguide layers 58b, 59b, respectively.

Further, when an assay by using a competition method is performed, instead of the primary antibody B₁ and the primary antibody B₀, the primary antibody (first binding substance) C₁ that specifically binds to the antigen A, which is the detection target substance, and the secondary antibody C₃, and the primary antibody C₀ that does not bind to the antigen A, which is the detection target substance, but specifically binds to the labeling secondary antibody C₃ are immobilized on the sensor portion. Further, as the solution for labeling, a solution containing the fluorescent-label binding substance C_{F} should be used. The fluorescent-label binding substance C_{F} contains the secondary antibody (third binding substance) C₃ that does not bind to the antigen A, which is the detection target substance, but specifically binds to the primary antibody, and a fluorescent substance, the surface of which is modified with the secondary antibody C₃ should be used. Further, a magnetic microparticle M has been added to the fluorescent-label binding substance C_{F}.

What is claimed is:

1. A detection method comprising the steps of:
preparing a sensor chip including a dielectric plate and a sensor portion that has at least a metal layer deposited on a surface of the dielectric plate;
binding a fluorescent-label binding substance in an amount corresponding to the amount of a detection target substance that is contained in a sample to the sensor portion by contacting the sample with the sensor portion;
irradiating the sensor portion with excitation light to generate an enhanced electric field on the sensor portion; and
detecting the amount of the detection target substance based on the amount of light generated by excitation of a fluorescent label contained in the fluorescent-label binding substance in the enhanced electric field, wherein a magnetic microparticle is added to the fluorescent-label binding substance, and wherein the amount of the detection target substance is detected in a state in which the fluorescent-label binding substance modified with the magnetic microparticle is attracted to the vicinity of the sensor portion by a magnetic field application means that is arranged on an opposite-surface side of the dielectric plate, the opposite-surface being opposite to the surface of the dielectric plate on which the metal layer is deposited.

2. A detection method, as defined in claim 1, wherein a fluorescent substance containing a plurality of fluorescent dye molecules enclosed by a material that transmits fluorescence output from the plurality of fluorescent dye molecules is used as the fluorescent label.

3. A detection method, as defined in claim 2, wherein the material prevents metal quenching that occurs when the fluorescent dye molecules are located close to the metal layer, and wherein the fluorescent substance is an anti-quenching fluorescent substance that prevents quenching.

4. A detection method, as defined in claim 1, wherein a first binding substance that specifically binds to the detection target substance is immobilized in the sensor portion of the sensor chip, and wherein the fluorescent-label binding substance contains one of a second binding substance that specifically binds to the detection target substance and a third binding substance that competes with the detection target substance and that specifically binds to the first binding substance and the fluorescent label modified with the one of the second binding substance and the third binding substance, and wherein the one of the second binding substance and the third binding substance is modified with the magnetic microparticle.

5. A detection method, as defined in claim 2, wherein the fluorescent substance is modified with the magnetic microparticle.

6. A detection method, as defined in claim 2, wherein the magnetic microparticle is included in the material enclosing the plurality of fluorescent dye molecules in the fluorescent substance.

7. A detection method, as defined in claim 1, wherein plasmons are excited in the metal layer by irradiation with the excitation light to generate the enhanced electric field by the plasmons, and wherein the amount of the detection target substance is detected by detecting, as the light generated by excitation of the fluorescent label, fluorescence output from the fluorescent label by the excitation of the fluorescent label.

8. A detection method, as defined in claim 1, wherein plasmons are excited in the metal layer by irradiation with the excitation light to generate the enhanced electric field by the plasmons, and wherein the amount of the detection target substance is detected by detecting, as the light generated by excitation of the fluorescent label, radiation light that radiates from the opposite-surface side of the dielectric plate, the radiation light being generated from plasmons that have been newly induced in the metal layer by fluorescence output from the fluorescent label by the excitation of the fluorescent label.

9. A detection method, as defined in claim 1, wherein the sensor chip includes an optical waveguide layer deposited on the metal layer, and wherein an optical waveguide mode is excited in the optical waveguide layer by irradiation with the excitation light to generate the enhanced electric field by the optical waveguide mode, and wherein the amount of the detection target substance is detected by detecting, as the light generated by excitation of the fluorescent label, fluorescence generated by excitation of the fluorescent label.

10. A detection method, as defined in claim 1, wherein the sensor chip includes an optical waveguide layer deposited on the metal layer, and wherein an optical waveguide mode is excited in the optical waveguide layer by irradiation with the excitation light to generate the enhanced electric field by the optical waveguide mode, and wherein the amount of the detection target substance is detected by detecting, as the light generated by excitation of the fluorescent label, radiation light that radiates from the opposite-surface side of the dielectric plate, the radiation light being generated from plasmons that have been newly induced in the metal layer by fluorescence output from the fluorescent label by the excitation of the fluorescent label.

11. A detection apparatus comprising:
a housing unit that houses a sensor chip including a dielectric plate and a sensor portion that includes at least a metal layer deposited on a surface of the dielectric plate;
an excitation-light irradiation optical system that irradiates the sensor portion with excitation light;
a light detection means that detects light in an amount corresponding to the detection target substance, the light being generated by irradiation with the excitation light; and
a magnetic field generation means arranged on an opposite-surface side of the dielectric plate, the opposite-surface being opposite to the surface of the dielectric plate on which the metal layer is deposited when the sensor chip is housed in the housing unit.

12. A sample cell for detection comprising:
a base that has a flow path through which a liquid sample flows down;
an injection opening for injecting the liquid sample into the flow path, the injection opening being provided on the upstream side of the flow path;
an air hole for causing the liquid sample that has been injected from the injection opening to flow toward the downstream side of the flow path, the air hole being provided on the downstream side of the flow path; and
a sensor chip portion provided between the injection opening and the air hole in the flow path, wherein the sensor chip includes a dielectric plate that is provided on at least a part of the inner wall of the flow path and a sensor portion that has at least a metal layer deposited on a predetermined area of a sample-contact surface of the dielectric plate.

13. A sample cell for detection, as defined in claim 12, wherein the sensor portion includes an immobilization layer that specifically binds to a fluorescent-label binding substance, and wherein a first binding substance that specifically binds to a detection target substance is immobilized on the sensor portion.

14. A sample cell for detection, as defined in claim 13, wherein the fluorescent-label binding substance contains one of a second binding substance that specifically binds to the detection target substance and a third binding substance that competes with the detection target substance and that specifically binds to the first binding substance and a fluorescent label that is modified with the one of the second binding substance and the third binding substance, and wherein a magnetic microparticle is added to the fluorescent-label binding substance, and wherein the fluorescent-label binding substance is immobilized in the flow path on the upstream side of the sensor portion.

15. A sample cell for detection, as defined in claim 12, wherein an optical waveguide layer is provided on the metal layer in the sensor portion.

16. A kit for detection comprising:
a sample cell; and
a solution for labeling,
wherein the sample cell includes:
a base that has a flow path through which a liquid sample flows down;
an injection opening for injecting the liquid sample into the flow path, the injection opening being provided on the upstream side of the flow path;
an air hole for causing the liquid sample that has been injected from the injection opening to flow toward the downstream side of the flow path, the air hole being provided on the downstream side of the flow path;
a sensor chip portion provided between the injection opening and the air hole in the flow path, the sensor chip including a dielectric plate that is provided on at least a part of the inner wall of the flow path and a sensor portion that has at least a metal layer deposited on a predetermined area of a sample-contact surface of the dielectric plate; and
a first binding substance that is immobilized on the sensor portion, and that specifically binds to a detection target substance,
and wherein the solution for labeling contains a fluorescent-label binding substance that contains one of a second binding substance that specifically binds to the detection target substance and a third binding substance that competes with the detection target substance and that specifically binds to the first binding substance and a fluorescent label that is modified with the one of the second binding substance and the third binding substance, and wherein a magnetic microparticle is added to the fluorescent-label binding substance, and wherein the solution for labeling is injected into the flow path to flow down the flow path together with the injection of the liquid sample or after the liquid sample has flowed down the flow path.

17. A kit for detection, as defined in claim 16, wherein an optical waveguide layer is provided on the metal layer in the sensor portion.
